(19) United States
(12) Patent Application Publication
(10) Pub. No.: US 2026/0262076 A1
(43) Pub. Date: Sep. 3, 2026

(54) INITIAL NETWORK ACCESS CONFIGURATIONS FOR ENERGY HARVESTING ENABLED USER EQUIPMENTS

(71) Applicant: QUALCOMM Incorporated, San Diego, CA (US)

(72) Inventors: Ahmed ELSHAFIE, San Diego, CA (US); Linhai HE, San Diego, CA (US); Yuchul KIM, San Diego, CA (US); Zhikun WU, Beijing (CN); Huilin XU, Temecula, CA (US); Seyedkianoush HOSSEINI, San Diego, CA (US)

(21) Appl. No.: 18/875,300

(22) PCT Filed: Aug. 1, 2022
(86) PCT No.: PCT/CN2022/109400

§ 371 Date: Dec. 16, 2024

(51) Int. Cl. H04W 74/00; H02J 50/00

(52) U.S. Cl. CPC H04W 74/006; H02J 50/001

(57) ABSTRACT

An energy harvesting enabled user equipment (UE) (e.g., a UE including an energy harvesting device) may have difficulty performing an initial network access procedure with a network node of a wireless communication network in scenarios where the UE has a low energy state (e.g., a battery level below a threshold), a low charging rate (e.g., a battery charging rate below a first threshold), and/or a high discharging rate (e.g., a battery discharging rate greater than or equal to a second threshold). In the aspects described herein, a UE receives configuration information associated with an initial network access procedure, wherein the configuration information is based on at least one of an energy harvesting class of the UE, a current charging rate of the UE, a current discharging rate of the UE, or a current energy state of the UE. The UE performs at least a portion of the initial network access procedure based on the configuration information.

### BACKGROUND

### Technical Field

The present disclosure relates generally to communication systems, and more particularly, to initial network access configurations for energy harvesting enabled user equipments (UEs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The aspects described herein include configurations of threshold values, power control parameters, and other parameters and information associated with an initial network access procedure (e.g., a four-step RACH procedure, a two-step RACH procedure) for a UE based on one or more of an energy harvesting class of the UE, a current charging rate of the UE, a current discharging rate of the UE, and a current energy state of the UE. For example, the current discharging rate of the UE may include power consumption at the UE due to operation of one or more of radio frequency (RF), hardware, and signal processing components, any loss of charge or energy over time due to leakage or imperfections of a power source (e.g., an energy storage unit, such as a battery) of the UE, and/or other causes or conditions that may contribute to the discharge of the power source of the UE. The aspects described herein further include manners of indicating to the UE the threshold values, power control parameters, and other parameters and information associated with an initial network access procedure (also referred to as an initial access procedure).

The aspects described herein further include configurations of the earliest times a UE may perform a next communication of an initial network access message and manners of indicating the earliest times to a network node. These aspects may adjust the timing (e.g., delay) of one or more communications of an initial network access procedure to allow an energy harvesting enabled device (e.g., a UE including an energy harvesting device) sufficient time to harvest an adequate amount of energy to perform a next communication of the initial network access procedure.

In an aspect of the disclosure, a method, a computer-readable medium, and an apparatus are provided. The apparatus may be a user equipment (UE). The UE receives configuration information associated with an initial network access procedure, wherein the configuration information is based on at least one of an energy harvesting class of the apparatus, a current charging rate of the apparatus, a current discharging rate of the apparatus, or a current energy state of the apparatus. The UE performs at least a portion of the initial network access procedure based on the configuration information.

In an aspect of the disclosure, a method, a computer-readable medium, and an apparatus are provided. The apparatus may be a network node. The network node transmits configuration information associated with an initial network access procedure, wherein the configuration information is based on at least one of an energy harvesting class of a user equipment (UE), a current charging rate of the UE, the current discharging rate of the UE, or a current energy state of the UE. The network access node performs at least a portion of the initial network access procedure based on the configuration information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 shows a diagram illustrating an example disaggregated base station architecture.

FIG. 5 is a signal flow diagram illustrating an example four-step random access procedure performed between a UE and a network node.

FIG. 6 is a signal flow diagram illustrating an example two-step random access procedure performed between a UE and a network node.

FIGS. 7A and 7B are a signal flow diagram in accordance with various aspects of the disclosure.

FIG. 8 is a flowchart of a method of wireless communication.

FIG. 9 is a flowchart of a method of wireless communication.

FIG. 10 is a conceptual data flow diagram illustrating the data flow between different means/components in an example apparatus.

FIG. 11 is a diagram illustrating an example of a hardware implementation for an apparatus employing a processing system.

FIG. 12 is a flowchart of a method of wireless communication.

FIG. 13 is a flowchart of a method of wireless communication.

FIG. 14 is a conceptual data flow diagram illustrating the data flow between different means/components in an example apparatus.

FIG. 15 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

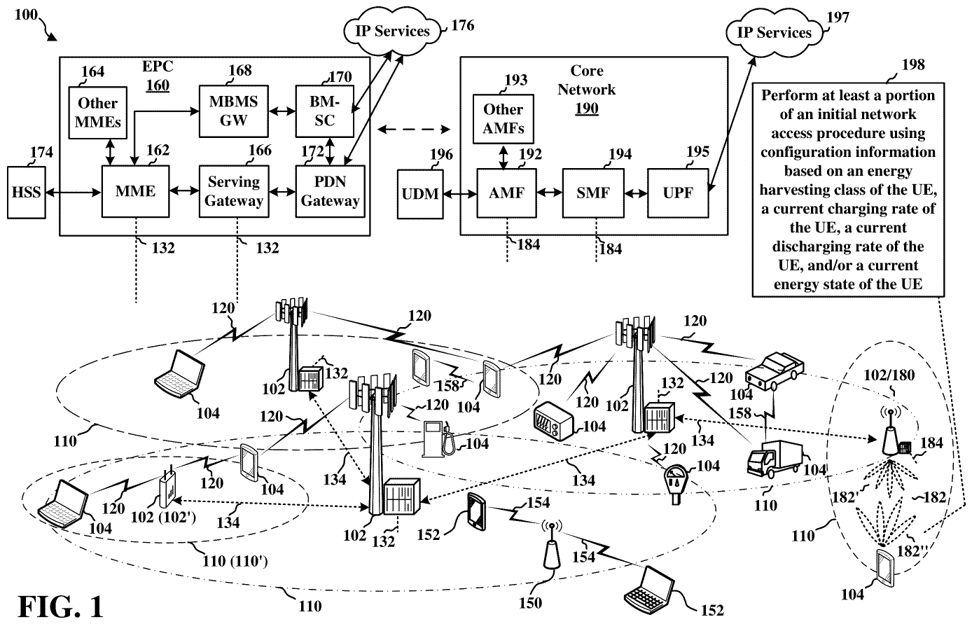

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to perform at least a portion of an initial network access procedure using configuration information based on an energy harvesting class of the UE, a current charging rate of the UE, a current discharging rate of the UE (e.g., a rate of energy (power) being consumed at the UE and/or a rate of energy leakage of a power source (e.g., battery) of the UE due to impairments or imperfections, etc.), and/or a current energy state of the UE (198). Although the following description may be focused on 5G NR, the concepts described herein may be applicable to other similar areas, such as LTE, LTE-A, CDMA, GSM, and other wireless technologies.

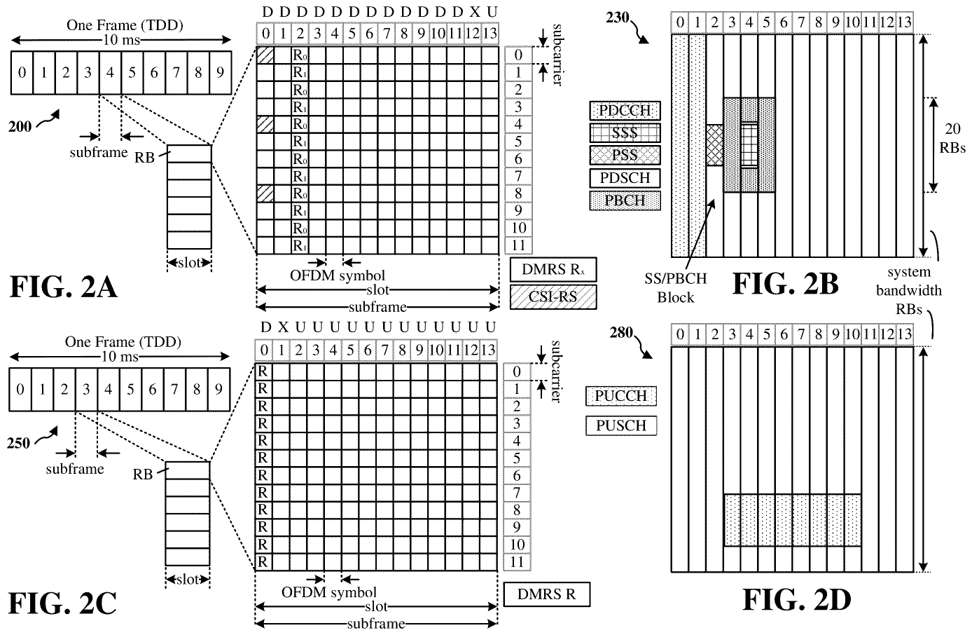

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}*15 kKz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (abbreviated herein as SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

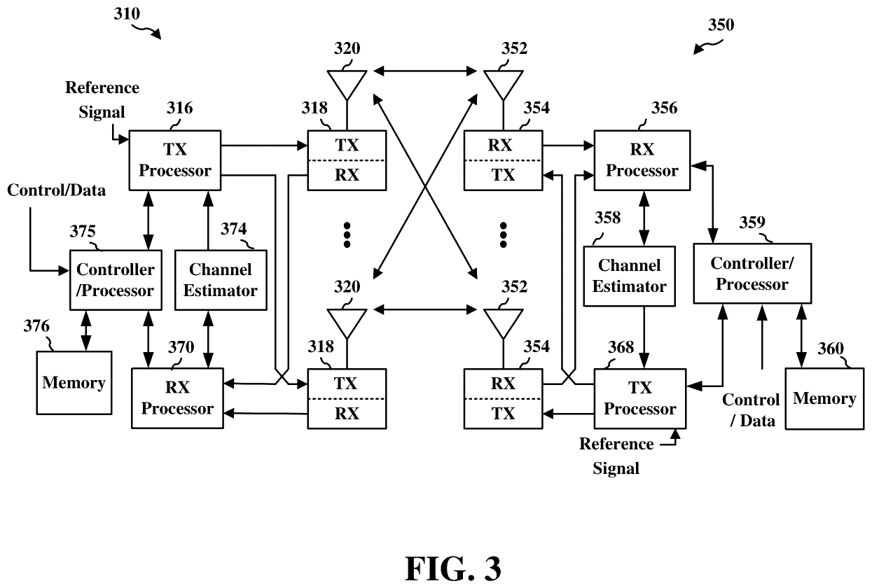

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, onto mapping physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

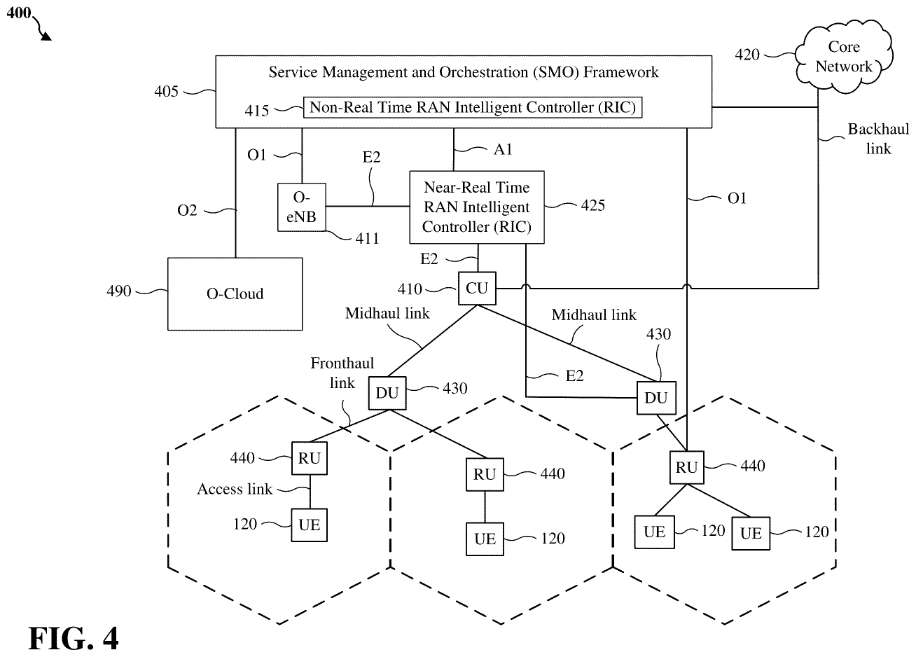

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 120 via one or more radio frequency (RF) access links. In some implementations, the UE 120 may be simultaneously served by multiple RUs 440.

Each of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 120. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

Energy harvesting technology has been attracting interest in the context of UEs having reduced capability (e.g., RedCap devices) and Passive Internet of things (PIOT) devices (e.g., radio frequency identification (RFID) tags). Devices powered by energy harvesting may opportunistically harvest energy from sources available in their environment, such as solar, heat, and ambient RF radiation, etc., and may store the energy in a rechargeable battery.

In some examples, UEs (e.g., including premium UEs, such as smartphones) may implement energy harvesting devices to charge a battery of the UE. In other examples, sensor devices for transmitting identification and/or tracking information may implement energy harvesting devices to provide all or a portion of the energy needed for operation of the sensor devices. For example, if a sensor device needs to intermittently transmit a tracking signal, the sensor device may use energy harvested in the period following a transmission of a tracking signal to power the next transmission of the tracking signal.

Protocol enhancements to support operation using intermittently available energy harvested from the environment are becoming increasingly valuable. For example, mobile communication networks (e.g., 5G NR networks) may support Energy Harvesting enabled Communication Services (EHECS) for energy harvesting enabled UEs, which may include power sourcing, security, access control/connectivity management, positioning, and other functions. Such protocol enhancements may consider variations in the amounts of harvested energy at UEs and the network traffic of the UEs. However, a device operating on intermittently available energy harvested from the environment may not be able to perform successive communications within a certain window of time and/or may not be able to sustain long continuous reception/transmission. It should be noted that devices powered by energy harvesting may not be limited to the RedCap use case and solutions should also be applicable to non-RedCap use cases.

An energy harvesting enabled UE may have difficulty performing an initial network access procedure with a network node of a wireless communication network in scenarios where the UE has a low energy state (e.g., a battery level below a threshold), a low charging rate (e.g., a battery charging rate below a first threshold), and/or a high discharging rate (e.g., a battery discharging rate greater than or equal to a second threshold). The aspects described herein may overcome these difficulties of a UE when performing an initial network access procedure.

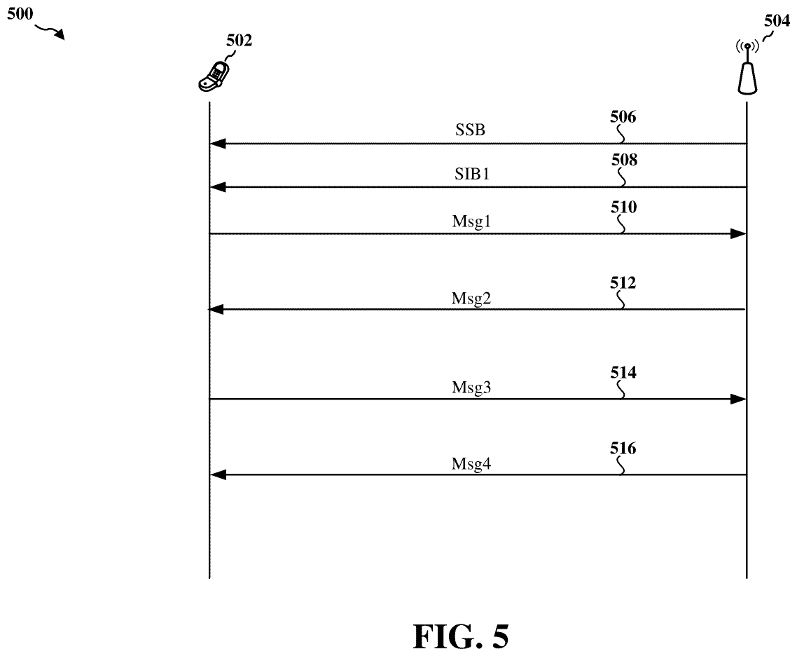

FIG. 5 is a signal flow diagram 500 illustrating an example four-step random access channel (RACH) procedure performed between a UE 502 and a network node 504. The network node 504 may be a base station. The four-step RACH procedure may be a contention-based random access procedure (CBRA) and may be initiated by the UE 502 for initial access to the network (e.g., to achieve UL synchronization with the network node 504).

The UE 502 may receive an SSB 506 and a system information block (SIB1) 508. The SIB1 508 may include random access channel (RACH) configuration information. The UE 502 may receive the SIB1 508 using PDSCH resources indicated by the PDCCH.

The UE 502 may initiate the four-step RACH procedure by transmitting a physical random access channel (PRACH) preamble in message 1 (Msg1) 510. Message 1 (Msg1) 510 may be referred to as a random access message and may be the initial message of the four-step RACH procedure. Upon detection of the PRACH preamble, the network node 504 responds with message 2 (Msg2) 512 including a random access response (RAR). The network node 504 may use a PDCCH for scheduling and a PDSCH for transmission of message 2 (Msg2) 512. Message 2 512 may include a timing advance, a UL grant for transmission of message 3 (Msg3) 514 by the UE 502 using the PUSCH, and a temporary cell radio network temporary identifier (TC-RNTI).

The UE 502 may transmit message 3 (Msg3) 514 using the PUSCH. Message 3 (Msg3) 514 may include an RRC connection request, a scheduling request, a buffer status, and/or other information (e.g., small data). The network node 504 may transmit a contention resolution via message 4 (Msg4) 516 using the PDCCH for scheduling and the PDSCH for transmission of message 4 (Msg4) 516.

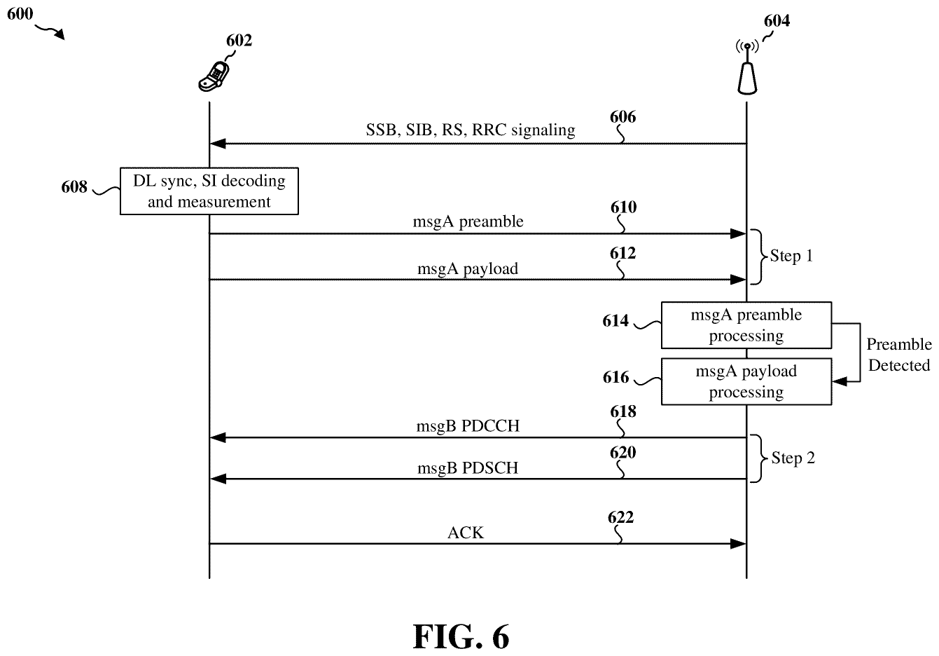

FIG. 6 is a signal flow diagram illustrating an example two-step random access channel (RACH) procedure performed between a UE 602 and a network node 604. Use cases for the two-step RACH procedure include transitioning from an RRC idle or inactive state to an RRC connected state, transmission of small data in the RRC idle or inactive state, a handover from a source cell to a target cell in the RRC connected mode. In the RRC connected mode, the UE 602 recovers a loss of UL synchronization.

The two-step RACH procedure may be a contention-based random access procedure (CBRA) and may be initiated by the UE 602 for initial access to the network (e.g., to achieve UL synchronization with the network node 604). As shown in FIG. 6, the UE 602 may receive cell detection information 606 from the network node 604. In some aspects of the disclosure, the cell detection information 606 may include an SSB, SIB, RS, and/or RRC signaling. At 608, the UE 602 may acquire downlink synchronization, decode system information (SI), and may perform one or more measurements.

The UE 602 may initiate the two-step RACH procedure by transmitting a message A (msgA) preamble 610 to the network node 604. The msgA preamble 610 may be referred to as a random access message and may be transmitted on the PRACH. The UE 602 may transmit a message A (msgA) payload 612 using the PUSCH. The msgA payload 612 may carry an RRC request, a buffer state report, and/or other suitable information. In some examples, the msgA payload 612 may include the information (e.g., small data) contained in message 3 (Msg3) 514 of the four-step RACH procedure described with reference to FIG. 5. The transmissions of the msgA preamble 610 and the msgA payload 612 represent step 1 of the two-step RACH procedure.

At 614, the network node 604 processes the msgA preamble 610. When the preamble is detected, the network node 604, at 616, processes the msgA payload 612.

The network node 604 responds by transmitting a message B (msgB) PDCCH 618 for scheduling a message B (msgB) PDSCH. The network node 604 transmits the msgB PDSCH 620, which may include at least the information contained in message 2 (Msg2) 512 and message 4 (Msg4) 516 of the four-step RACH procedure described with reference to FIG. 5. The UE 602 may acknowledge the message B PDSCH 620 with a HARQ acknowledgement (ACK) message 622 using the PUCCH.

The aspects described herein include configurations of threshold values, power control parameters, and other parameters and information associated with an initial network access procedure (e.g., a four-step RACH procedure, a two-step RACH procedure) for a UE based on one or more of an energy harvesting class of the UE, a current charging rate of the UE, a current discharging rate of the UE, and a current energy state of the UE. The aspects described herein further include manners of indicating to the UE the threshold values, power control parameters, and other parameters and information associated with an initial network access procedure (also referred to as an initial access procedure).

The aspects described herein further include configurations of the earliest times a UE may perform a next communication of an initial network access message and manners of indicating the earliest times to a network node. These aspects may adjust the timing (e.g., delay) of one or more communications of an initial network access procedure to allow an energy harvesting enabled device (e.g., a UE including an energy harvesting device) sufficient time to harvest an adequate amount of energy to perform a next communication of the initial network access procedure.

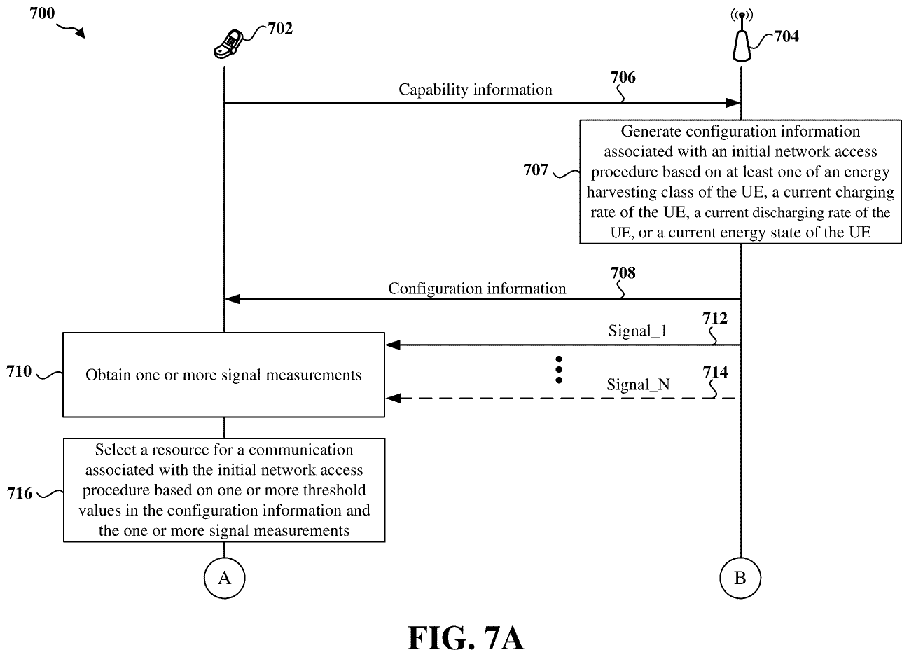

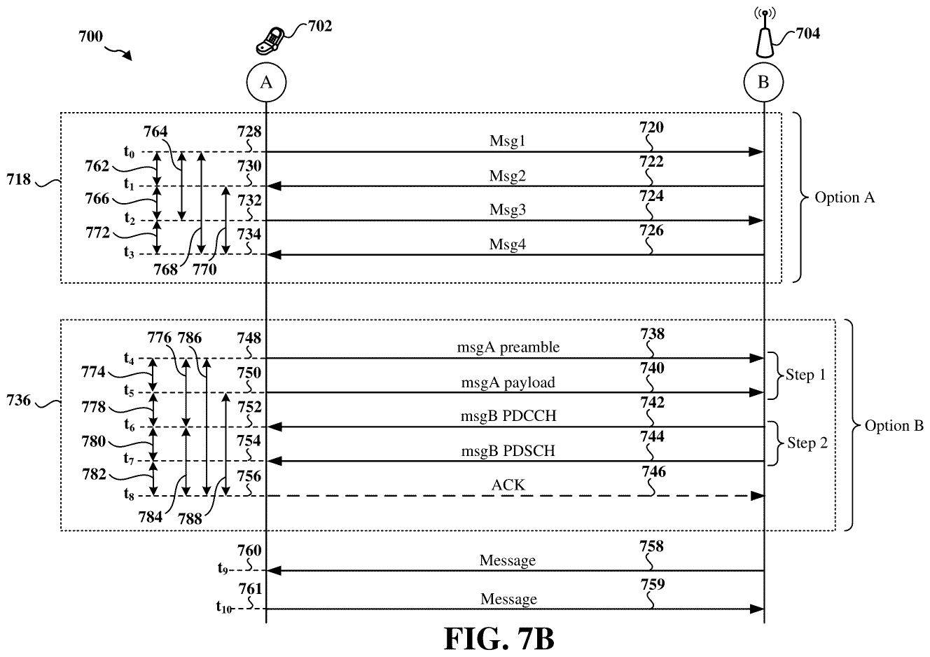

FIGS. 7A and 7B are a signal flow diagram 700 in accordance with various aspects of the disclosure. The signal flow diagram 700 includes a UE 702 and a network node 704. In some examples, the network node 704 may be a base station.

The UE 702 may transmit a message 706 including capability information (also referred to as a capability report) of the UE 702. The capability information may indicate one or more of an energy harvesting class of the UE 702, a current charging rate of the UE 702, a current discharging rate of the UE 702, and a current energy state of the UE 702.

In some aspects, the energy harvesting class of the UE 702 may be associated with one or more of a minimum charging rate of the UE 702, a default charging rate of the UE 702, a minimum discharging rate of the UE 702, a default discharging rate of the UE 702, a type of energy harvesting supported at the UE 702, a minimum time gap between communications at the UE 702, and a capacity of an energy source of the UE 702. For example, multiple energy harvesting classes may be defined and a certain UE (e.g., the UE 702) may belong to one of the multiple energy harvesting classes.

In some examples, each energy harvesting class may be assigned a different numerical value or a different label (e.g., “class_1,” “class_2,” “class_3,” and so on). In some examples, the energy harvesting class of a UE may be an indication of a performance level of the UE with respect to energy harvesting and/or power source (e.g., battery) usage and management. In one nonlimiting example, a first UE having a higher minimum or default charging rate, a lower minimum or default discharging rate, a lower minimum time gap between communications, and a higher capacity energy source (e.g., battery) may be in a higher energy harvesting class (e.g., class_1) relative to a second UE having a lower minimum or default charging rate, a higher minimum or default discharging rate, a higher minimum time gap between communications, and a lower capacity energy source (e.g., battery). In such example, the second UE may belong to a lower energy harvesting class (e.g., class_3) relative to the first UE.

For example, the minimum charging rate of the UE 702 may indicate a minimum rate of electric charge that the battery of the UE 702 receives (e.g., from one or more energy harvesting devices of the UE 702). For example, the minimum rate of electric charge may be indicated as a numerical value in units of amp hours (Ah). For example, the default charging rate of the UE 702 may indicate an average or expected rate of electric charge that the battery of the UE 702 may receive (e.g., from one or more energy harvesting devices of the UE 702). For example, the default rate of electric charge may be indicated as a numerical value in units of amp hours (Ah).

For example, the minimum discharging rate of the UE may indicate a minimum power consumption at the UE resulting from the operation of one or more of radio frequency (RF), hardware, and signal processing components of the UE, any loss of charge or energy over time due to leakage or imperfections of a power source (e.g., an energy storage unit, such as a battery) of the UE, and/or other causes or conditions that may contribute to the discharge of the power source of the UE. For example, the default discharging rate of the UE may indicate an average or expected power consumption at the UE resulting from the operation of one or more of radio frequency (RF), hardware, and signal processing components of the UE, any loss of charge or energy over time due to leakage or imperfections of a power source (e.g., an energy storage unit, such as a battery) of the UE, and/or other causes or conditions that may contribute to the discharge of the power source of the UE.

For example, the type of energy harvesting supported at the UE 702 may include one or more types of energy harvesting technologies, such as radio frequency (RF) energy harvesting, solar energy harvesting, laser-based energy harvesting, and any other suitable type of energy harvesting technology. In some implementations, the UE 702 may include at least one energy harvesting device to support one type of energy harvesting technology. In other implementations, the UE 702 may include multiple energy harvesting devices to support multiple types of energy harvesting technologies.

In some aspects, the minimum time gap between communications at the UE 702 may indicate the minimum amount of time the UE 702 may need to perform two communications. In some examples, the two communications performed at the UE 702 may be consecutive communications. In some examples, the two communications may include a transmission of a first signal from the UE 702 followed by a transmission of a second signal from the UE 702. In some examples, the two communications may include a reception of a first signal at the UE 702 followed by a reception of a second signal at the UE 702. In some examples, the two communications may include a transmission of a first signal from the UE 702 followed by a reception of a second signal at the UE 702. In some examples, the two communications may include a reception of a first signal at the UE 702 followed by a transmission of a second signal from the UE 702.

In some aspects, the capacity of the energy source of the UE 702 may indicate a total amount of electric charge that a battery of the UE 702 can store. In some examples, the capacity of the energy source of the UE 702 may be indicated as a numerical value in units of amp hours (Ah) or other appropriate units. The capacity of the energy source of the UE 702 may determine the number of signal receptions and/or signal transmissions the UE 702 may perform in a certain duration.

The current charging rate of the UE 702 may indicate a rate of electric charge that is currently being delivered to a battery of UE the 702. For example, the rate of electric charge may be indicated as a numerical value in units of amp hours (Ah). In some examples, all or a portion of the electric charge currently being delivered to a battery of UE 702 may be generated by one or more energy harvesting devices of the UE 702. For example, if the UE 702 includes a solar energy harvesting device configured to charge the battery of the UE 702, the current charging rate of the UE 702 may increase as the amount of sunlight reaching the solar energy harvesting device is increased, or may decrease as the amount of sunlight reaching the solar energy harvesting device is reduced.

The current discharging rate of the UE 702 may indicate a rate of energy (power) being consumed at the UE 702 and/or a rate of energy leakage of a power source (e.g., battery) of the UE 702 due to impairments or imperfections, etc. In some examples, the current charging and/or discharging rates of the UE 702 may be quantized (mapped to a smaller set of possible values) at the UE 702 based on (pre)-configured thresholds as defined in communications standards or specifications, or as indicated to the UE 702 by explicit signaling from the network node 704. In some examples, such thresholds may be updated and provided to the UE 702 via signaling (e.g., using L1/L2/L3 signaling).

The current energy state of the UE 702 may indicate an amount of electrical energy (e.g., electric charge) currently stored in a battery of the UE 702. In some examples, the amount of electrical energy currently stored in a battery of the UE 702 may be indicated as a numerical value in units of amp hours (Ah). In some examples, the amount of electrical energy currently stored in a battery of the UE 702 may be indicated as a percentage relative to the total storage capacity of the battery.

At 707, the network node 704 may generate configuration information associated with an initial network access procedure (e.g., a four-step RACH procedure, a two-step RACH procedure) based on at least one of the energy harvesting class of the UE, the current charging rate of the UE, the current discharging rate of the UE, or the current energy state of the UE. The network node 704 may transmit a message 708 including the configuration information.

The UE 702 may receive the message 708 including the configuration information associated with the initial network access procedure (e.g., a four-step RACH procedure, a two-step RACH procedure). In the aspects described herein, the configuration information is based on one or more of the previously described energy harvesting class of the UE, the current charging rate of the UE, the current discharging rate of the UE, and the current energy state of the UE.

The configuration information in the message 708 may include one or more threshold values for one or more signal measurements associated with the initial network access procedure. For example, the configuration information may include a reference signal received power (RSRP) threshold for CSI-RS (rsrp-ThresholdCSI-RS), an RSRP threshold for SSB (rsrp-ThresholdSSB), and/or an RSRP threshold for a selection between a normal UL (NUL) carrier and a secondary UL (SUL) carrier (rsrp-ThresholdSSB-SUL). In some examples, the RSRP threshold for SSB may serve as an RSRP threshold for beam failure recovery at the UE 702.

The configuration information in the message 708 may include power control information for a signal transmission from the UE 702, such as a random access preamble transmission. For example, the power control information may include a preamble received target power (preambleReceivedTargetPower) indicating an amount of power the UE 702 is to use for a random access preamble transmission. The power control information may include a maximum number of random access preamble transmissions that the UE 702 is allowed to perform.

The power control information may include one or more of a power-ramping factor (powerRampingStep), a power-ramping factor for a prioritized random access procedure (powerRampingStepHighPriority), and a scaling factor for a prioritized random access procedure (scalingFactorBI).

The configuration information in the message 708 may indicate one or more occasions to transmit a signal transmission associated with a random access procedure (e.g., a four-step RACH procedure, a two-step RACH procedure). In one example, the one or more occasions may be indicated with a random access occasion list parameter (ra-OccasionList) that defines PRACH occasion(s) associated with a CSI-RS in which a MAC entity may transmit a random access preamble. In another example, the one or more occasions may be indicated with a PRACH mask index that defines PRACH occasion(s) associated with an SSB in which a MAC entity may transmit a random access preamble (ra-ssb-OccasionMaskIndex).

In some examples, the UE 702 may determine an amount of power to use for a random access preamble transmission based on the following equation (1):

$${P}_{PRACH} = preambleReceivedTargetPower + DP + ( PPRC - 1 ) ( PPRS ) \qquad ( equation 1 )$$

where P_{PRACH} represents an amount of power to be used for a random access preamble transmission, preambleReceivedTargetPower represents an RRC parameter (e.g., from the network node 704) indicating the amount of power to use for a random access preamble transmission, DP (also referred to as DELTA_PREAMBLE) represents a power offset value, PPRC (also referred to as PREAMBLE_POWER_RAMPING_COUNTER) represents a value of a counter that is incremented after each retransmission of a preamble, and PPRS (also referred to as PREAMBLE_POWER_RAMPING_STEP) represents a value derived from an RRC parameter (e.g., powerRampingStep) indicating a power-ramping factor.

In some examples, for a contention-free random access (CFRA) procedure, the UE 702 may be configured with SSB or CSI-RS random access resources. In one example, if the resources configured for the CFRA procedure include SSB resources, the UE may select an SSB with SS-RSRP above rsrp-ThresholdSSB from among the associated SSBs and may select the corresponding random access resources. In another example, if the resources configured for the CFRA procedure include CSI-RS resources, the UE may select a CSI-RS with CSI-RSRP above rsrp-ThresholdCSI-RS from among the associated CSI-RSs and may select the corresponding random access resources.

In some aspects, if the current energy state of the UE 702 is below a threshold, one or more signal measurement thresholds associated with a beam selection operation (e.g., rsrp-ThresholdSSB) may be reduced. This may enable the UE 702 with a low energy state (e.g., low battery charge) to search for and accept at least one beam more quickly, thereby reducing power consumption at the UE 702 and extending the operation time of the UE 702. In some aspects, if the current energy state of the UE 702 is greater than or equal to the threshold, the one or more signal measurement thresholds associated with a beam selection operation (e.g., rsrp-ThresholdSSB) may be increased. This may enable the UE 702 to identify at least one high quality beam before connecting to the network node 704 in scenarios where the UE 702 needs to reduce transmission/reception errors and avoid energy consumption due to retransmissions.

In some aspects, the configuration information in the message 708 may indicate one or more sizes of a time gap (also referred to as a maximum allowed time gap or a maximum time offset) that the UE 702 is allowed to request or apply. The time gap may represent the minimum amount of time the UE 702 may need between two communications performed at the UE as described herein. The one or more sizes of the time gap may be based on one or more of the current charging rate of the UE 702, the current discharging rate of the UE 702, the current energy state of the UE 702, and the parameters defined for the energy harvesting class of the UE 702.

In some aspects of the disclosure, the UE 702 may receive the message 708 including the configuration information during initial access or via dedicated signaling in a connected mode. In some examples, the network node 704 may support multiple types of energy harvesting devices (e.g., RF energy harvesting devices, such as radio frequency identification (RFID) tags, solar energy harvesting devices, laser-based energy harvesting devices, etc.). Accordingly, the network node 704 may determine the configuration information (e.g., one or more parameters and/or one or more parameter values) based on one or more of the energy harvesting class of the UE 702, the current charging rate of the UE 702, the current discharging rate of the UE 702, and the current energy state of the UE 702 when the UE 702 reports its capability information.

In some examples, the network node 704 may provide the configuration information via an SSB. Therefore, in these examples, the message 708 may be an SSB. For example, the network node 704 may include the configuration information in a master information block (MIB) carried on a physical broadcast channel (PBCH) (e.g., a PBCH in the SSB).

In some examples, the network node 704 may provide the configuration information via a system information block (e.g., SIB1). Therefore, in these examples, the message 708 may be a SIB1. In one example, the network node 704 may include the configuration information in SIB1 and may transmit SIB1 on PDSCH. In another example, the network node 704 may include the configuration information in DCI for SIB1 and may transmit the DCI on PDCCH. In some examples, the network node 704 may provide the configuration information via one or more other SIBs (OSIBs), which may be different from SIB1. The network node 704 may transmit the one or more other SIBs on PDCCH or PDSCH.

In some examples, the network node 704 may provide the configuration information in a message of a RACH procedure. For example, if the RACH procedure is a four-step RACH procedure (e.g., the four-step RACH procedure 718 as described with reference to FIG. 7B), the network node 704 may provide the configuration information in message 2 (Msg2) (also referred to as a random access response (RAR) message) of the four-step RACH procedure. In one example, the network node 704 may include the configuration information in the PDDCH for message 2 (Msg2). In another example, the network node 704 may include the configuration information in message 2 (Msg2) and may transmit message 2 (Msg2) in the PDSCH.

For example, if the RACH procedure is a four-step RACH procedure, the network node 704 may provide the configuration information in message 4 (Msg4) (also referred to as a contention resolution message) of the four-step RACH procedure. In one example, the network node 704 may include the configuration information in DCI for message 4 (Msg4) and may transmit the DCI in the PDCCH. In another example, the network node 704 may include the configuration information in message 4 (Msg4) and may transmit message 4 (Msg4) in the PDSCH.

For example, if the RACH procedure is a two-step RACH procedure (e.g., the two-step RACH procedure 736 as described with reference to FIG. 7B), the network node 704 may provide the configuration information in a message (e.g., msgB PDCCH 742) of the two-step RACH procedure. In one example, the network node 704 may include the configuration information in DCI and may transmit the DCI in the msgB PDCCH 742. In another example, the network node 704 may include the configuration information in the msgB PDSCH 744.

As previously mentioned, the UE 702 may receive the message 708 including the configuration information via dedicated signaling in a connected mode. For example, the message 708 may be an RRC message, a MAC control element (CE) message (also referred to as a MAC-CE message), DCI, a SIB, a message transmitted in the PDSCH, or a wakeup signal (WUS) transmitted to the UE 702 using a Uu interface (also referred to as a Uu-WUS signaling).

As shown in FIG. 7A, at 710, the UE 702 may obtain one or more signal measurements (e.g., reference signal measurements). In some examples, the UE 702 may measure one or more signals from the network node 704. For example, if a first signal (Signal_1) 712 from the network node 704 is a reference signal (e.g., CSI-RS), the UE 702 may measure a strength (e.g., the RSRP) of the first signal (Signal_1) 712. In some examples, the UE 702 may obtain additional or other signal measurements using other signals from the network node 704, such as the Nth signal 714.

At 716, the UE 702 may select a resource for a communication associated with the initial network access procedure based on one or more threshold values in the configuration information and the one or more signal measurements. The resource may be a NUL carrier, a SUL carrier, or a contention-free random access resource associated with an SSB or CSI-RS.

With reference to FIG. 7B, the UE 702 may perform at least a portion of an initial network access procedure based on the configuration information in the message 708. For example, the UE 702 may perform a four-step RACH procedure 718 (indicated as option A in FIG. 7B) or a two-step RACH procedure 736 (indicated as option B in FIG. 7B).

In the four-step RACH procedure 718, the UE 702 may initiate the four-step RACH procedure by transmitting a physical random access channel (PRACH) preamble in message 1 (Msg1) 720 at time to 728. Message 1 (Msg1) 720 may be referred to as a random access message and may be the initial message of the four-step RACH procedure. Upon detection of the PRACH preamble, the network node 704 responds with message 2 (Msg2) 722 (also referred to as RAR message) which is received at the UE 702 at time t₁ 730. The network node 704 may use a PDCCH for scheduling and a PDSCH for transmission of the message 2 (Msg2) 722. Message 2 (Msg2) 722 may include a UL grant for the UE 702 for transmission of message 3 (Msg3) 724 using a PUSCH at time t₂ 732. The network node 704 may transmit a contention resolution via message 4 (Msg4) 726 (which is received at the UE 702 at time t₃ 734) using the PDCCH for scheduling and the PDSCH for transmission of message 4 (Msg4) 726.

In some aspects of the disclosure, the UE 702 may indicate a minimum amount of time (e.g., a minimum time gap) needed between two communications associated with the four-step RACH procedure 718. In some examples, the UE 702 may indicate in message 1 (Msg1) 720 a first amount of time 762 the UE 702 needs to receive message 2 (Msg2) 722, where the first amount of time 762 is with respect to the transmission of message 1 (Msg1) 720 at time t₀ 728. In some examples, the UE 702 may indicate in message 1 (Msg1) 720 a second amount of time 764 the UE 702 needs to transmit message 3 (Msg3) 724, where the second amount of time 764 is with respect to the transmission of message 1 (Msg1) 720 at time t₀ 728. In some examples, the UE 702 may indicate in message 1 (Msg1) 720 a third amount of time 766 the UE 702 needs to transmit message 3 (Msg3) 724, where the third amount of time 766 is with respect to the reception of message 2 (Msg2) 722 at time t₁ 730.

In some examples, the UE 702 may indicate in message 1 (Msg1) 720 a fourth amount of time 768 the UE 702 needs to receive message 4 (Msg4) 726, where the fourth amount of time 768 is with respect to the transmission of message 1 (Msg1) 720 at time to 728. In some examples, the UE 702 may indicate in message 1 (Msg1) 720 a fifth amount of time 770 the UE 702 needs to receive message 4 (Msg4) 726, where the fifth amount of time 770 is with respect to the reception of message 2 (Msg2) 722 at time t₁ 730. In some examples, the UE 702 may indicate in message 1 (Msg1) 720 or message 3 (Msg3) 724 a sixth amount of time 772 the UE 702 needs to receive message 4 (Msg4) 726, where the sixth amount of time 772 is with respect to the transmission of message 3 (Msg3) 724 at time t₂ 732.

In some aspects of the disclosure, the UE 702 may determine any one of the amounts of time 762, 764, 766, 768, 770, 772 based on the current charging rate of the UE 702, the current discharging rate of the UE, and the amount of power consumed at the UE 702 when performing two communications associated with the four-step RACH procedure 718. As discussed herein, the two communications may be two signal transmissions, two signal receptions, a signal transmission followed by a signal reception, or a signal reception followed by a signal transmission. In one example, the UE 702 may determine lower values for the first amount of time 762 as the current charging rate increases and may determine higher values for the first amount of time 762 as the current charging rate decreases.

In some aspects, the UE 702 may indicate any one of the amounts of time 762, 764, 766, 768, 770, 772 as a duration relative to a reference time, an absolute time, or a codepoint from one or more preconfigured codepoints. For example, the reference time or the absolute time may be a time (e.g., time to 728, time t₁ 730, time t₂ 732, or time t₃ 734) at which a message of the four-step RACH procedure 718 is transmitted or received at the UE 702.

In the two-step RACH procedure 736, the UE 702 may initiate the two-step RACH procedure by transmitting a message A (msgA) preamble 738 to the network node 704 at time t₄ 748. The msgA preamble 738 may be referred to as a random access message and may be transmitted on the PRACH. The UE 702 may transmit a message A (msgA) payload 740 using the PUSCH at time t₅ 750. The msgA payload 740 may carry an RRC request, a buffer state report, and/or other suitable information. In some examples, the msgA payload 740 may include the information (e.g., small data) contained in message 3 (Msg3) 724 in the previously four-step RACH procedure 718. The transmissions of the msgA preamble 738 and the msgA payload 740 represent step 1 of the two-step RACH procedure 736.

The network node 704 may process the msgA preamble 738. When the network node 704 detects the msgA preamble 738, the network node 704 may process the msgA payload 740.

The network node 704 may transmit a message B (msgB) PDCCH 742 at time t₆ 752 for scheduling a message B (msgB) PDSCH. The network node 704 transmits the msgB PDSCH 744 which is received at the UE 702 at time t₇ 757. The msgB PDSCH 744 may include at least the information contained in message 2 (Msg2) 722 and message 4 (Msg4) 726 in the previously described four-step RACH procedure 718. The UE 702 may acknowledge the message B PDSCH 744 with a HARQ ACK message 746 using the PUCCH at time to 756. The transmissions of the msgB PDCCH 742 and the msgB PDSCH 744 at the network node 704 represent step 2 of the two-step RACH procedure 736.

In some aspects of the disclosure, the UE 702 may indicate a minimum amount of time needed between two communications associated with the two-step RACH procedure 736. In some examples, the UE 702 may indicate in the msgA preamble 738 a first amount of time 774 the UE 702 needs to transmit the msgA payload 740, where the first amount of time 774 is with respect to the transmission of the msgA preamble 738 at time t₄ 748. In some examples, the UE 702 may indicate in the msgA preamble 738 a second amount of time 776 the UE 702 needs to receive the msgB PDCCH 742, where the second amount of time 776 is with respect to the transmission of the msgA preamble 738 at time t₄ 748. In some examples, the UE 702 may indicate in the msgA payload 740 a third amount of time 778 the UE 702 needs to receive the msgB PDCCH 742, where the third amount of time 778 is with respect to the transmission of the msgA payload 740 at time t₅ 750.

In some examples, the UE 702 may indicate in the msgA preamble 738 and/or the msgA payload 740 a fourth amount of time 780 the UE 702 needs to receive the msgB PDSCH 744, where the fourth amount of time 780 is with respect to the reception of the msgB PDCCH 742 at time t₆ 752. In some examples, the UE 702 may indicate in the msgA preamble 738 and/or the msgA payload 740 a fifth amount of time 782 the UE 702 needs to transmit the HARQ ACK message 746 using the PUCCH at time to 756, where the fifth amount of time 782 is with respect to the reception of msgB PDSCH 744 at time t₇ 754.

In some examples, the UE 702 may indicate in the msgA preamble 738 and/or the msgA payload 740 a sixth amount of time 784 the UE 702 needs to transmit the HARQ ACK message 746 using the PUCCH at time t₈ 756, where the sixth amount of time 784 is with respect to the reception of the msgB PDCCH 742 at time t₆ 752. In some examples, the UE 702 may indicate in the msgA preamble 738 a seventh amount of time 786 the UE 702 needs to transmit the HARQ ACK message 746 using the PUCCH at time to 756, where the seventh amount of time 786 is with respect to the transmission of the msgA preamble 738 at time t₄ 748. In some examples, the UE 702 may indicate in the msgA payload 740 an eighth amount of time 788 the UE 702 needs to transmit the HARQ ACK message 746 using the PUCCH at time t₈ 756, where the eighth amount of time 788 is with respect to the transmission of the msgA payload 740 at time t₅ 750.

In some aspects of the disclosure, the UE 702 may determine any one of the amounts of time 774, 776, 778, 780, 782, 784, 786, 788 based on the current charging rate of the UE 702, the current discharging rate of the UE, and the amount of power consumed at the UE 702 when performing two communications associated with the two-step RACH procedure 736. As discussed herein, the two communications may be two signal transmissions, two signal receptions, a signal transmission followed by a signal reception, or a signal reception followed by a signal transmission. In one example, the UE 702 may determine lower values for the first amount of time 774 as the current charging rate increases and may determine higher values for the first amount of time 774 as the current charging rate decreases.

In some aspects, the UE 702 may indicate any one of the amounts of time 774, 776, 778, 780, 782, 784, 786, 788 as a duration relative to a reference time (e.g., a delta value from a reference time), an absolute time, or a codepoint from one or more preconfigured codepoints. For example, the reference time or the absolute time may be a time (e.g., time t₄ 748, time t₅ 750, time t₆ 752, time t₇ 754 or time to 756) at which a message of the two-step RACH procedure 736 is transmitted or received at the UE 702.

In some examples, the network node 704 may indicate one or more sizes of a time gap that the UE 702 may apply between two communications at the UE 702 in a message of a random access channel procedure. For example, if the random access channel procedure is a four-step RACH procedure (e.g., the four-step RACH procedure 718 as described with reference to FIG. 7B), the network node 704 may indicate the one or more sizes of the time gap in message 2 (Msg2) 722 of the four-step RACH procedure. In one example, the network node 704 may indicate the one or more sizes of the time gap via the PDDCH (e.g., in DCI) for the message 2 (Msg2) 722. In another example, the network node 704 may indicate the one or more sizes of the time gap via the PDSCH (e.g., in message 2 (Msg2) 722 transmitted on PDSCH). In some examples, the network node 704 may indicate the one or more sizes of the time gap via a combination of the PDDCH and the PDSCH.

In some examples, the one or more sizes of the time gap indicated in message 2 (Msg2) 722 may indicate an allowable time gap (e.g., a maximum allowed time gap) between reception of message 2 (Msg2) 722 and transmission of message 3 (Msg3) 724 and/or an allowable time gap (e.g., a maximum allowed time gap) between transmission of message 3 (Msg3) 724 and reception of message 4 (Msg4) 726 at the UE 702. In some examples, each of the one or more sizes of the time gap may be based on different energy harvesting classes of a UE.

In some examples, the one or more sizes of the time gap indicated in message 2 (Msg2) 722 may indicate an allowable time gap (e.g., a maximum allowed time gap) between reception of message 2 (Msg2) 722 and reception of a message (e.g., the message 758 received at t₉ 760) arriving after message 4 (Msg4) 726. For example, the message 758 may be an OSIB.

For example, if the RACH procedure is a four-step RACH procedure, the network node 704 may indicate the one or more sizes of a time gap (e.g., including a maximum allowed time gap) that the UE 702 may apply between two communications at the UE 702 in message 4 (Msg4) 726. In one example, the network node 704 may indicate the one or more sizes of the time gap via the PDDCH (e.g., in DCI) for message 4 (Msg4) 726. In another example, the network node 704 may indicate the one or more sizes of the time gap via the PDSCH (e.g., in message 4 (Msg4) 726 transmitted on PDSCH). In some examples, the network node 704 may indicate the one or more sizes of the time gap via a combination of the PDDCH and the PDSCH.

In some examples, the one or more sizes of the time gap indicated in message 4 (Msg4) 726 may indicate an allowable time gap between reception of message 4 (Msg4) 726 and reception of a message after message 4 (Msg4) 726. For example, the UE 702 may apply the allowable time gap between reception of message 4 (Msg4) 726 and reception of the message 758. For example, the message 758 may be an OSIB).

For example, if the RACH procedure is a two-step RACH procedure (e.g., the two-step RACH procedure 736 as described with reference to FIG. 7B), the network node 704 may indicate the one or more sizes of the time gap in the msgB PDCCH 742 of the two-step RACH procedure.

In some examples, the one or more sizes of the time gap indicated in the msgB PDCCH 742 may indicate an allowable time gap between reception of the msgB PDCCH 742 and reception of the msgB PDSCH 744 and/or an allowable time gap between reception of the msgB PDSCH 744 and reception of a message (e.g., message 758) arriving after the msgB PDSCH 744. In some examples, each of the one or more sizes of the time gap may be based on different energy harvesting classes of a UE. For example, the message 758 may be an OSIB.

For example, if the RACH procedure is a two-step RACH procedure, the network node 704 may indicate the one or more sizes of a time gap that the UE 702 may apply between two communications at the UE 702 in the msgB PDSCH 744. In some examples, the one or more sizes of the time gap indicated in the msgB PDSCH 744 may indicate an allowable time gap between reception of the msgB PDSCH 744 and reception of a message (e.g., message 758) arriving after the msgB PDSCH 744. In some examples, each of the one or more sizes of the time gap may be based on different energy harvesting classes of a UE. For example, the message 758 may be an OSIB.

In some aspects of the disclosure, the UE 702 may indicate an amount of time the UE 702 needs to receive a message (e.g., the message 758) or transmit a message (e.g., the message 759 transmitted at t₁₀ 761) after transmission of an acknowledgment (e.g., the HARQ ACK message 746) for a message of an initial network access procedure. For example, the message 758 may be a next downlink message (e.g., a data message), SIB, or other appropriate message. For example, the message 759 may be a next uplink message (e.g., a data message) or other appropriate message.

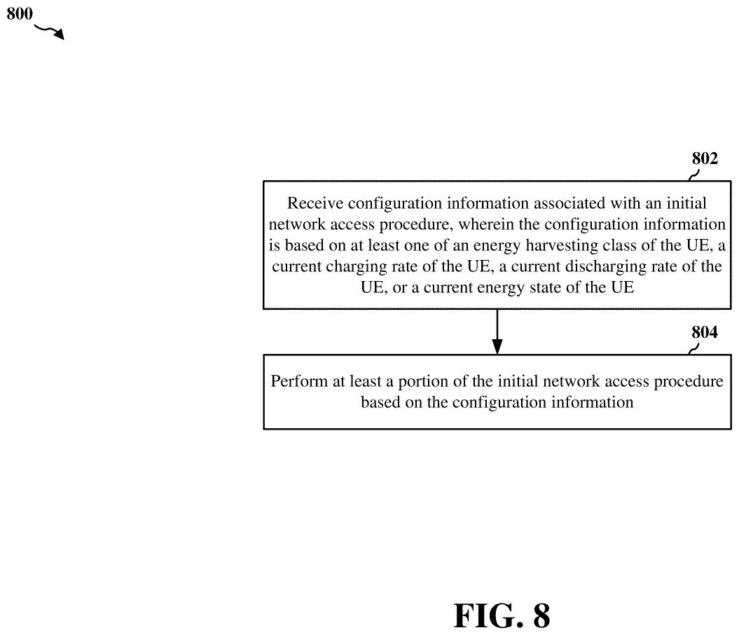

FIG. 8 is a flowchart 800 of a method of wireless communication. The method may be performed by a UE (e.g., the UE 104, 702; the apparatus 1002/1002′; the processing system 1114, which may include the memory 360 and which may be the entire UE 104, 702 or a component of the UE 104, 702, such as the TX processor 368, the RX processor 356, and/or the controller/processor 359).

At 802, the UE receives configuration information associated with an initial network access procedure, wherein the configuration information is based on at least one of an energy harvesting class of the UE, a current charging rate of the UE, a current discharging rate of the UE, or a current energy state of the UE. For example, with reference to FIG. 7A, the UE 702 receives the message 708 including the configuration information.

In some examples, the configuration information includes one or more parameter values for a signal transmission or a signal reception based on at least one of the energy harvesting class of the apparatus, the current charging rate of the apparatus, the current discharging rate of the apparatus, or the current energy state of the apparatus. In some examples, the configuration information includes one or more threshold values for one or more signal measurements associated with the initial network access procedure. In some examples, the initial network access procedure includes at least one signal transmission from the UE and the configuration information includes at least one of power control information for the signal transmission, a maximum number of transmissions for the signal transmission, or one or more occasions to transmit the signal transmission. For example, the at least one signal transmission from the UE may be message 1 (Msg1) 720 including a PRACH preamble and the power control information may include a preamble received target power (preambleReceivedTargetPower) indicating an amount of power the UE 702 is to use for transmission of message 1 (Msg1) 720.

In some aspects, the configuration information is received before or during the initial network access procedure (e.g., before or during the four-step RACH procedure 718 or the two-step RACH procedure 736). In some aspects, the configuration information is received in at least one of an SSB, an SIB, or a random access message. In some aspects, the configuration information is received via a dedicated signaling in a connected mode. In some aspects, the configuration information includes a maximum allowed time gap between two communications associated with the initial network access procedure, wherein the maximum allowed time gap is based on at least the energy harvesting class of the apparatus.

At 804, the UE performs at least a portion of the initial network access procedure based on the configuration information. In some aspects, the initial network access procedure includes a four-step RACH procedure (e.g., the four-step RACH procedure 718). In these aspects, the UE may transmit a first message (e.g., Msg1 720) of the four-step RACH procedure, wherein the first message indicates at least one of a first amount of time (e.g., the first amount of time 762) to receive a second message (e.g., Msg2 722) of the four-step RACH procedure, a second amount of time (e.g., the second amount of time 764) to transmit a third message (e.g., Msg3 724) of the four-step RACH procedure, or a third amount of time (e.g., the fourth amount of time 768) to receive a fourth message (e.g., Msg4 726) of the four-step RACH procedure. In some examples, the second amount of time is relative to a transmission time of the first message or a reception time of the second message, and wherein the third amount of time is relative to the transmission time of the first message, the reception time of the second message, or a transmission time of the third message. In some aspects, the UE transmits a message of the four-step RACH procedure, wherein the message indicates an amount of time to receive a last message (e.g., Msg4 726) of the four-step RACH procedure.

In some aspects, the initial network access procedure includes a two-step RACH procedure (e.g., the two-step RACH procedure 736). In these aspects, the UE may transmit a first message (e.g., msgA preamble 738) associated with a first step of the two-step RACH procedure, wherein the first message includes a preamble and indicates at least one of a first amount of time (e.g., the first amount of time 774 in FIG. 7B) to transmit a second message (e.g., msgA payload 740) associated with the first step, a second amount of time (e.g., the second amount of time 776 in FIG. 7B) to receive a third message (e.g., the msgB PDCCH 742) associated with a second step of the two-step RACH procedure, a third amount of time (e.g., the fourth amount of time 780 in FIG. 7B) to receive a fourth message (e.g., the msgB PDSCH 744) associated with the second step, or a fourth amount of time (e.g., the seventh amount of time 786 in FIG. 7B) to transmit an acknowledgement (e.g., the HARQ ACK message 746) for the fourth message. In some examples, at least one of the first amount of time, the second amount of time, the third amount of time, or the fourth amount of time is indicated as one of a duration relative to a reference time, an absolute time, or a codepoint from one or more preconfigured codepoints. In some examples, the first amount of time, the second amount of time, and the third amount of time are relative to a transmission time of the first message. In some examples, the third amount of time is relative to a reception time of the second message of the two-step RACH procedure. In some examples, the fourth amount of time is relative to a transmission time of the first message or a reception time of the second message.

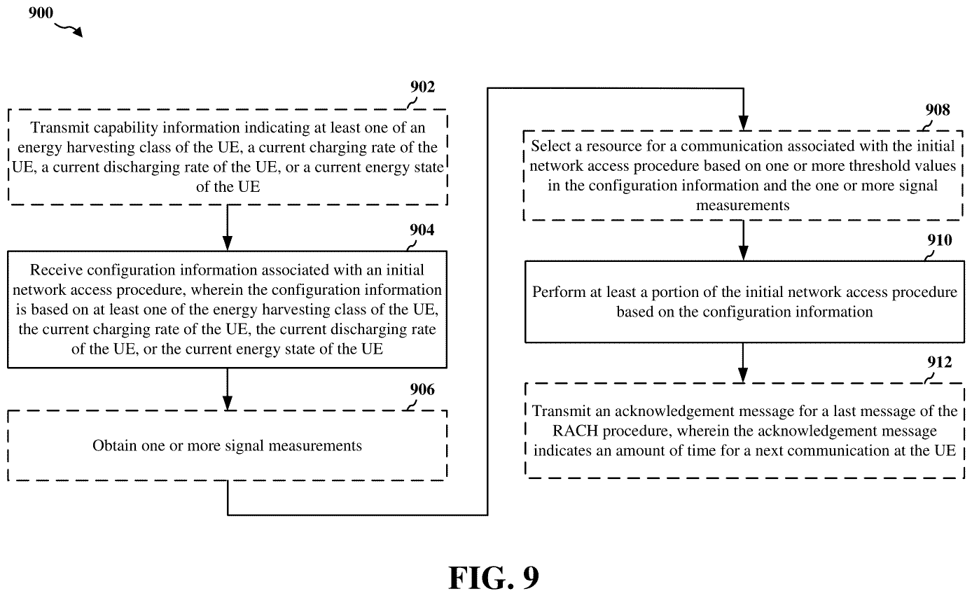

FIG. 9 is a flowchart 900 of a method of wireless communication. The method may be performed by a UE (e.g., the UE 104, 702; the apparatus 1002/1002′; the processing system 1114, which may include the memory 360 and which may be the entire UE 104, 702 or a component of the UE 104, 702, such as the TX processor 368, the RX processor 356, and/or the controller/processor 359). In FIG. 9, blocks indicated with dashed lines represent optional blocks.

At 902, the UE transmits capability information indicating at least one of an energy harvesting class of the UE, a current charging rate of the UE, a current discharging rate of the UE, or a current energy state of the UE. For example, with reference to FIG. 7A, the UE 702 transmits a message 706 including capability information. In some examples, the energy harvesting class of the UE is associated with at least one of a minimum charging rate of the UE, a default charging rate of the UE, a minimum discharging rate of the UE, a default discharging rate of the UE, a type of energy harvesting supported at the UE, a minimum time gap between two communications at the UE, or a capacity of an energy source of the UE.

At 904, the UE receives configuration information associated with an initial network access procedure, wherein the configuration information is based on at least one of the energy harvesting class of the UE, the current charging rate of the UE, the current discharging rate of the UE, or the current energy state of the UE. For example, with reference to FIG. 7A, the UE 702 receives the message 708 including the configuration information.

In some examples, the configuration information includes one or more parameter values for a signal transmission or a signal reception based on at least one of the energy harvesting class of the apparatus, the current charging rate of the apparatus, the current discharging rate of the apparatus, or the current energy state of the apparatus. In some examples, the configuration information includes one or more threshold values for one or more signal measurements associated with the initial network access procedure. In some examples, the initial network access procedure includes at least one signal transmission from the UE and the configuration information includes at least one of power control information for the signal transmission, a maximum number of transmissions for the signal transmission, or one or more occasions to transmit the signal transmission. For example, the at least one signal transmission from the UE may be message 1 (Msg1) 720 including a PRACH preamble and the power control information may include a preamble received target power (preambleReceivedTargetPower) indicating an amount of power the UE 702 is to use for transmission of message 1 (Msg1) 720.

In some aspects, the configuration information is received before or during the initial network access procedure (e.g., before or during the four-step RACH procedure 718 or the two-step RACH procedure 736). In some aspects, the configuration information is received in at least one of an SSB, an SIB, or a random access message. In some aspects, the configuration information is received via a dedicated signaling in a connected mode. In some aspects, the configuration information includes a maximum allowed time gap between two communications associated with the initial network access procedure, wherein the maximum allowed time gap is based on at least the energy harvesting class of the apparatus.

At 906, the UE obtains one or more signal measurements. For example, as described herein with reference to FIG. 7A, the UE 702 may measure one or more signals from the network node 704. For example, if a first signal (Signal_1) 712 from the network node 704 is a reference signal (e.g., CSI-RS), the UE 702 may measure a strength (e.g., the RSRP) of the first signal (Signal_1) 712. In some examples, the UE 702 may obtain additional or other signal measurements using other signals from the network node 704, such as the Nth signal 714.

At 908, the UE selects a resource for a communication associated with the initial network access procedure based on one or more threshold values in the configuration information and the one or more signal measurements. For example, with reference to FIG. 7A, the UE 702 at 716 may select a resource for a communication associated with the initial network access procedure based on one or more threshold values in the configuration information and the one or more signal measurements. The resource may be a NUL carrier, a SUL carrier, or a contention-free random access resource associated with an SSB or CSI-RS.

At 910, the UE performs at least a portion of the initial network access procedure based on the configuration information. In some aspects, the initial network access procedure includes a four-step RACH procedure (e.g., the four-step RACH procedure 718). In these aspects, the UE may transmit a first message (e.g., Msg1 720) of the four-step RACH procedure, wherein the first message indicates at least one of a first amount of time (e.g., the first amount of time 762) to receive a second message (e.g., Msg2 722) of the four-step RACH procedure, a second amount of time (e.g., the second amount of time 764) to transmit a third message (e.g., Msg3 724) of the four-step RACH procedure, or a third amount of time (e.g., the fourth amount of time 768) to receive a fourth message (e.g., Msg4 726) of the four-step RACH procedure. In some examples, the second amount of time is relative to a transmission time of the first message or a reception time of the second message, and wherein the third amount of time is relative to the transmission time of the first message, the reception time of the second message, or a transmission time of the third message. In some aspects, the UE transmits a message of the four-step RACH procedure, wherein the message indicates an amount of time to receive a last message (e.g., Msg4 726) of the four-step RACH procedure.

In some aspects, the initial network access procedure includes a two-step RACH procedure (e.g., the two-step RACH procedure 736). In these aspects, the UE may transmit a first message (e.g., msgA preamble 738) associated with a first step of the two-step RACH procedure, wherein the first message includes a preamble and indicates at least one of a first amount of time (e.g., the first amount of time 774 in FIG. 7B) to transmit a second message (e.g., msgA payload 740) associated with the first step, a second amount of time (e.g., the second amount of time 776 in FIG. 7B) to receive a third message (e.g., the msgB PDCCH 742) associated with a second step of the two-step RACH procedure, a third amount of time (e.g., the fourth amount of time 780 in FIG. 7B) to receive a fourth message (e.g., the msgB PDSCH 744) associated with the second step, or a fourth amount of time (e.g., the seventh amount of time 786 in FIG. 7B) to transmit an acknowledgement (e.g., the HARQ ACK message 746) for the fourth message. In some examples, at least one of the first amount of time, the second amount of time, the third amount of time, or the fourth amount of time is indicated as one of a duration relative to a reference time, an absolute time, or a codepoint from one or more preconfigured codepoints. In some examples, the first amount of time, the second amount of time, and the third amount of time are relative to a transmission time of the first message. In some examples, the third amount of time is relative to a reception time of the second message of the two-step RACH procedure. In some examples, the fourth amount of time is relative to a transmission time of the first message or a reception time of the second message.

At 912, the UE transmits an acknowledgement message (e.g., the HARQ ACK message 746) for a last message of a RACH procedure, wherein the acknowledgement message indicates an amount of time for a next communication at the UE (e.g., reception of the message 758 received at t₉ 760). For example, the initial network access procedure may include the RACH procedure.

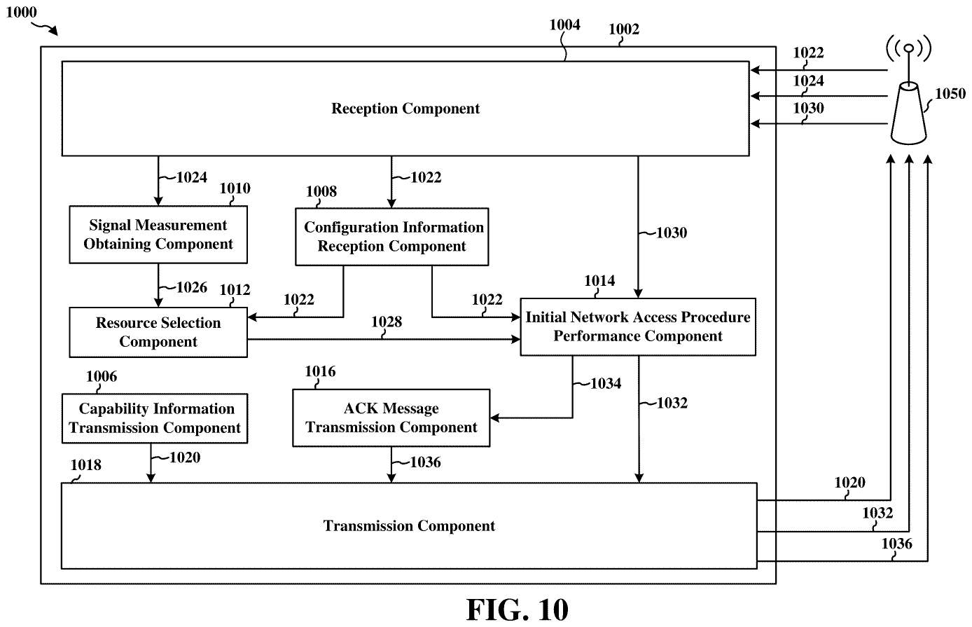

FIG. 10 is a conceptual data flow diagram 1000 illustrating the data flow between different means/components in an example apparatus 1002. The apparatus may be a UE.

The apparatus includes a reception component 1004 that receives downlink signals from a network node 1050.

The apparatus includes a capability information transmission component 1006 that transmits capability information 1020 (e.g., via the transmission component 1018) indicating at least one of the energy harvesting class of the apparatus, the current charging rate of the apparatus, the current discharging rate of the apparatus, or the current energy state of the apparatus.

The apparatus includes a configuration information reception component 1008 that receives configuration information 1022 (e.g., via the reception component 1004) associated with an initial network access procedure, wherein the configuration information is based on at least one of an energy harvesting class of the apparatus, a current charging rate of the apparatus, a current discharging rate of the apparatus, or a current energy state of the apparatus.

The apparatus includes a signal measurement obtaining component 1010 that obtains the one or more signal measurements. For example, the signal measurement obtaining component 1010 may receive a signal 1024 (e.g., a reference signal, such as a CSI-RS) from the network node 1050 and may measure the signal 1024.

The apparatus includes a resource selection component 1012 that selects a resource for a communication associated with the initial network access procedure based on the one or more threshold values in the configuration information and the one or more signal measurements. For example, the resource selection component 1012 may receive the one or more signal measurements via a signal 1026 from the signal measurement obtaining component 1010. For example, the resource selection component 1012 may receive the configuration information 1022 from the configuration information reception component 1008.

The apparatus includes an initial network access procedure performance component 1014 that performs at least a portion of the initial network access procedure based on the configuration information. For example, the initial network access procedure performance component 1014 may receive the configuration information 1022 from the configuration information reception component 1008. For example, the initial network access procedure performance component 1014 may receive information indicating the selected resources via a signal 1028 from the resource selection component 1012. For example, the initial network access procedure performance component 1014 may receive (e.g., via the reception component 1004) a message 1030 associated with an initial network access procedure and may transmit (e.g., via the transmission component 1018) a message 1032 associated with an initial network access procedure.

The apparatus includes an acknowledgement message transmission component 1016 transmits an acknowledgement message 1036 (e.g., via the transmission component 1018) for a last message of the RACH procedure, wherein the acknowledgement message 1036 indicates an amount of time for a next communication at the apparatus. For example, the acknowledgement message transmission component 1016 may receive the last message of the RACH procedure via the signal 1034 from the initial network access procedure performance component 1014.

The apparatus includes a transmission component 1018 that transmits uplink signals to the network node 1050.

The apparatus may include additional components that perform each of the blocks of the algorithm in the aforementioned flowcharts of FIGS. 8 and 9. As such, each block in the aforementioned flowcharts of FIGS. 8 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

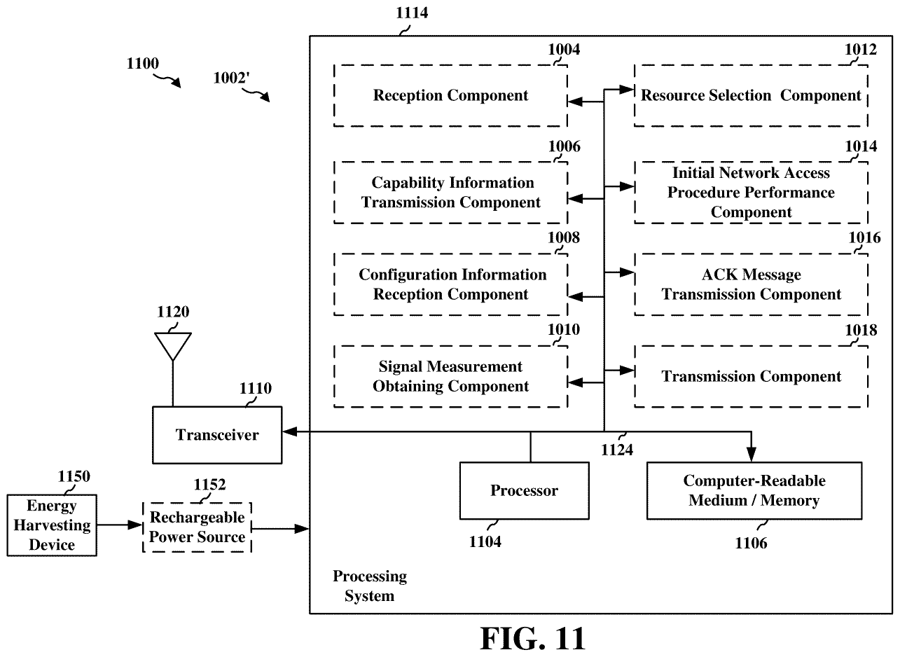

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, 1014, 1016, 1018 and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1018, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, 1012, 1014, 1016, 1018. The components may be software components running in the processor 1104, resident/stored in the computer readable medium/memory 1106, one or more hardware components coupled to the processor 1104, or some combination thereof. The processing system 1114 may be a component of the UE 350 and may include the memory 360 and/or at least one of the TX processor 368, the RX processor 356, and the controller/processor 359. Alternatively, the processing system 1114 may be the entire UE (e.g., see 350 of FIG. 3).

The apparatus 1002′ may be an energy harvesting enabled apparatus. For example, the apparatus 1002′ may be coupled to or may include an energy harvesting device 1150. In some implementations, the energy harvesting device 1150 may generate and provide electrical energy used for powering the apparatus 1002′. In some implementations, the energy harvesting device 1150 may provide the electrical energy to a rechargeable power source 1152 (e.g., a rechargeable battery) of the apparatus 1002′.

In one configuration, the apparatus 1002/1002′ for wireless communication includes means for receiving configuration information associated with an initial network access procedure, wherein the configuration information is based on at least one of an energy harvesting class of the apparatus, a current charging rate of the apparatus, a current discharging rate of the apparatus, or a current energy state of the apparatus, means for performing at least a portion of the initial network access procedure based on the configuration information, means for obtaining the one or more signal measurements, means for selecting a resource for a communication associated with the initial network access procedure based on the one or more threshold values in the configuration information and the one or more signal measurements, means for transmitting capability information indicating at least one of the energy harvesting class of the apparatus, the current charging rate of the apparatus, the current discharging rate of the apparatus, or the current energy state of the apparatus, means for transmitting a first message of the four-step RACH procedure, wherein the first message indicates at least one of a first amount of time to receive a second message of the four-step RACH procedure, a second amount of time to transmit a third message of the four-step RACH procedure, or a third amount of time to receive a fourth message of the four-step RACH procedure, means for transmitting a message of the four-step RACH procedure, wherein the message indicates an amount of time to receive a last message of the four-step RACH procedure, means for transmitting a first message associated with a first step of the two-step RACH procedure, wherein the first message includes a preamble and indicates at least one of a first amount of time to transmit a second message associated with the first step, a second amount of time to receive a third message associated with a second step of the two-step RACH procedure, a third amount of time to receive a fourth message associated with the second step, or a fourth amount of time to transmit an acknowledgement for the fourth message, means for transmitting an acknowledgement message for a last message of the RACH procedure, wherein the acknowledgement message indicates an amount of time for a next communication at the apparatus.

The aforementioned means may be one or more of the aforementioned components of the apparatus 1002 and/or the processing system 1114 of the apparatus 1002′ configured to perform the functions recited by the aforementioned means. As described supra, the processing system 1114 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

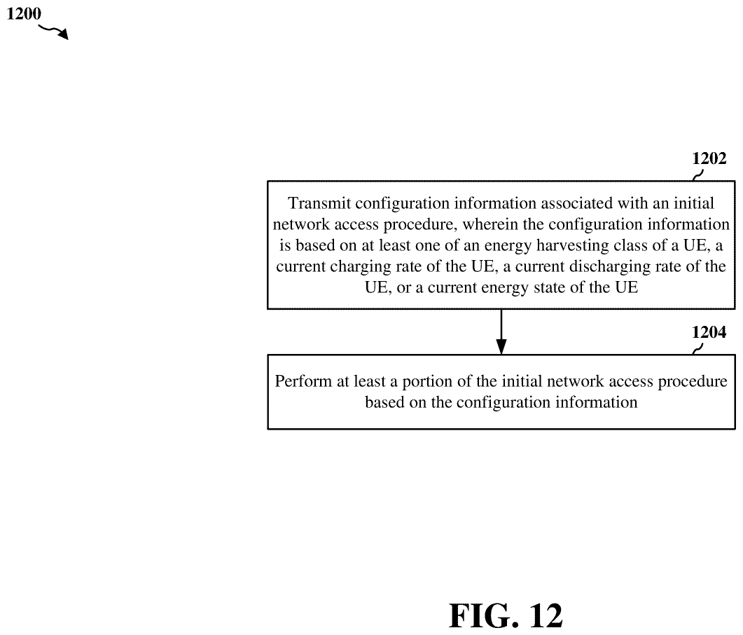

FIG. 12 is a flowchart 1200 of a method of wireless communication. The method may be performed by a network node (e.g., the network node 102, 704; the apparatus 1402/1402′; the processing system 1514, which may include the memory 376 and which may be the entire base station or a component of the base station, such as the TX processor 316, the RX processor 370, and/or the controller/processor 375).

At 1202, the network node transmits configuration information associated with an initial network access procedure, wherein the configuration information is based on at least one of an energy harvesting class of a UE, a current charging rate of the UE, a current discharging rate of the UE, or a current energy state of the UE. In some examples, the energy harvesting class of the UE is associated with at least one of a minimum charging rate of the UE, a default charging rate of the UE, a minimum discharging rate of the UE, a default discharging rate of the UE, a type of energy harvesting supported at the UE, a minimum time gap between two communications at the UE, or a capacity of an energy source of the UE. In some examples, the configuration information includes one or more parameter values for a signal transmission at the UE or a signal reception at the UE based on at least one of the energy harvesting class of the UE, the current charging rate of the UE, the current discharging rate of the UE, or the current energy state of the UE. In some examples, the configuration information includes a maximum allowed time gap between two communications associated with the initial network access procedure, wherein the maximum allowed time gap is based on at least the energy harvesting class of the UE.

At 1204, the network node performs at least a portion of the initial network access procedure based on the configuration information. In some aspects, the initial network access procedure includes a four-step RACH procedure. In these aspects, the network node receives a first message of the four-step RACH procedure, wherein the first message indicates at least one of a first amount of time to transmit a second message of the four-step RACH procedure, a second amount of time to receive a third message of the four-step RACH procedure, or a third amount of time to transmit a fourth message of the four-step RACH procedure.

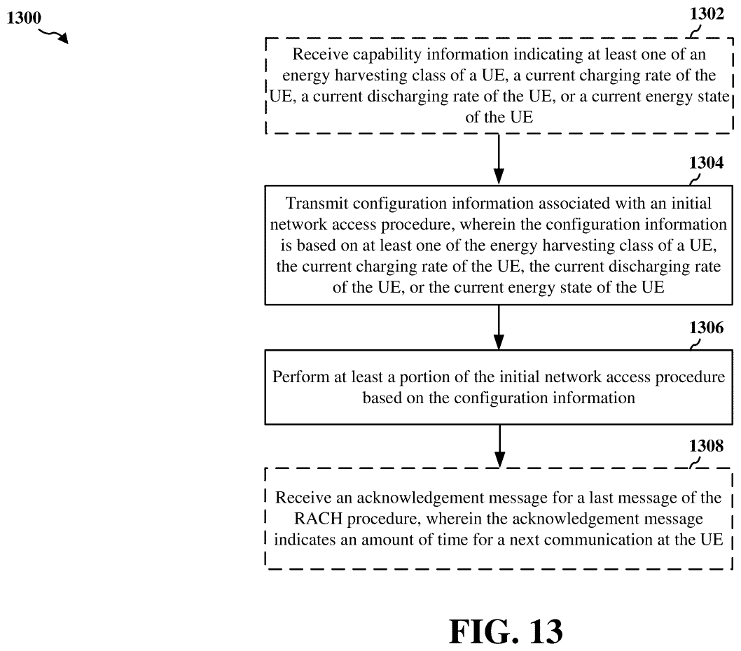

FIG. 13 is a flowchart 1300 of a method of wireless communication. The method may be performed by a network node (e.g., the network node 102, 704; the apparatus 1402/1402′; the processing system 1514, which may include the memory 376 and which may be the entire base station or a component of the base station (e.g., when the network node is implemented as a base station), such as the TX processor 316, the RX processor 370, and/or the controller/processor 375). In FIG. 13, blocks indicated with dashed lines represent optional blocks.

At 1302, the network node receives capability information indicating at least one of an energy harvesting class of a UE, a current charging rate of the UE, a current discharging rate of the UE, or a current energy state of the UE. For example, with reference to FIG. 7A, the network node 704 may receive a message 706 including the capability information. In some examples, the energy harvesting class of the UE is associated with at least one of a minimum charging rate of the UE, a default charging rate of the UE, a minimum discharging rate of the UE, a default discharging rate of the UE, a type of energy harvesting supported at the UE, a minimum time gap between two communications at the UE, or a capacity of an energy source of the UE.

At 1304, the network node transmits configuration information associated with an initial network access procedure, wherein the configuration information is based on at least one of the energy harvesting class of the UE, the current charging rate of the UE, the current discharging rate of the UE, or the current energy state of the UE. For example, with reference to FIG. 7A, the network node 704 may transmit the message 708 including the configuration information.

In some examples, the configuration information includes one or more parameter values for a signal transmission at the UE or a signal reception at the UE based on at least one of the energy harvesting class of the UE, the current charging rate of the UE, the current discharging rate of the UE, or the current energy state of the UE. In some examples, the configuration information includes one or more threshold values for one or more signal measurements (e.g., one or more signal measurements to be obtained by the UE) associated with the initial network access procedure. In some examples, the initial network access procedure includes at least one signal transmission from the UE and the configuration information includes at least one of power control information for the signal transmission, a maximum number of transmissions for the signal transmission, or one or more occasions to transmit the signal transmission. For example, the at least one signal transmission from the UE may be message 1 (Msg1) 720 including a PRACH preamble and the power control information may include a preamble received target power (preambleReceivedTargetPower) indicating an amount of power the UE 702 is to use for transmission of message 1 (Msg1) 720.

In some aspects, the configuration information is transmitted before or during the initial network access procedure (e.g., before or during the four-step RACH procedure 718 or the two-step RACH procedure 736). In some aspects, the configuration information is transmitted in at least one of an SSB, an SIB, or a random access message. In some aspects, the configuration information is transmitted via a dedicated signaling in a connected mode. In some aspects, the configuration information includes a maximum allowed time gap between two communications associated with the initial network access procedure, wherein the maximum allowed time gap is based on at least the energy harvesting class of the UE.

At 1306, the network node performs at least a portion of the initial network access procedure based on the configuration information. In some aspects, the initial network access procedure includes a four-step RACH procedure (e.g., the four-step RACH procedure 718). In these aspects, the network node 704 receives a first message (e.g., Msg1 720) of the four-step RACH procedure, wherein the first message indicates at least one of a first amount of time (e.g., the first amount of time 762) to transmit a second message (e.g., Msg2 722) of the four-step RACH procedure, a second amount of time (e.g., the second amount of time 764) to receive a third message (e.g., Msg3 724) of the four-step RACH procedure, or a third amount of time (e.g., the fourth amount of time 768) to transmit a fourth message (e.g., Msg4 726) of the four-step RACH procedure. In some examples, the second amount of time is relative to a reception time of the first message or a transmission time of the second message, and wherein the third amount of time is relative to the reception time of the first message, the transmission time of the second message, or a reception time of the third message. In some aspects, the UE transmits a message of the four-step RACH procedure, wherein the message indicates an amount of time to receive a last message (e.g., Msg4 726) of the four-step RACH procedure.

In some aspects, the initial network access procedure includes a two-step RACH procedure (e.g., the two-step RACH procedure 736). In these aspects, the network node 704 may receive a first message (e.g., msgA preamble 738) associated with a first step of the two-step RACH procedure, wherein the first message includes a preamble and indicates at least one of a first amount of time (e.g., the first amount of time 774 in FIG. 7B) to receive a second message (e.g., msgA payload 740) associated with the first step, a second amount of time (e.g., the second amount of time 776 in FIG. 7B) to transmit a third message (e.g., the msgB PDCCH 742) associated with a second step of the two-step RACH procedure, a third amount of time (e.g., the fourth amount of time 780 in FIG. 7B) to transmit a fourth message (e.g., the msgB PDSCH 744) associated with the second step, or a fourth amount of time (e.g., the seventh amount of time 786 in FIG. 7B) to receive an acknowledgement (e.g., the HARQ ACK message 746) for the fourth message. In some examples, at least one of the first amount of time, the second amount of time, the third amount of time, or the fourth amount of time is indicated as one of a duration relative to a reference time, an absolute time, or a codepoint from one or more preconfigured codepoints. In some examples, the first amount of time, the second amount of time, and the third amount of time are relative to a reception time of the first message.

At 1308, the network node receives an acknowledgement message (e.g., the HARQ ACK message 746) for a last message of the RACH procedure (e.g., msgB PDSCH 744), wherein the acknowledgement message indicates an amount of time for a next communication at the UE. In some aspects, the initial network access procedure may include the RACH procedure.

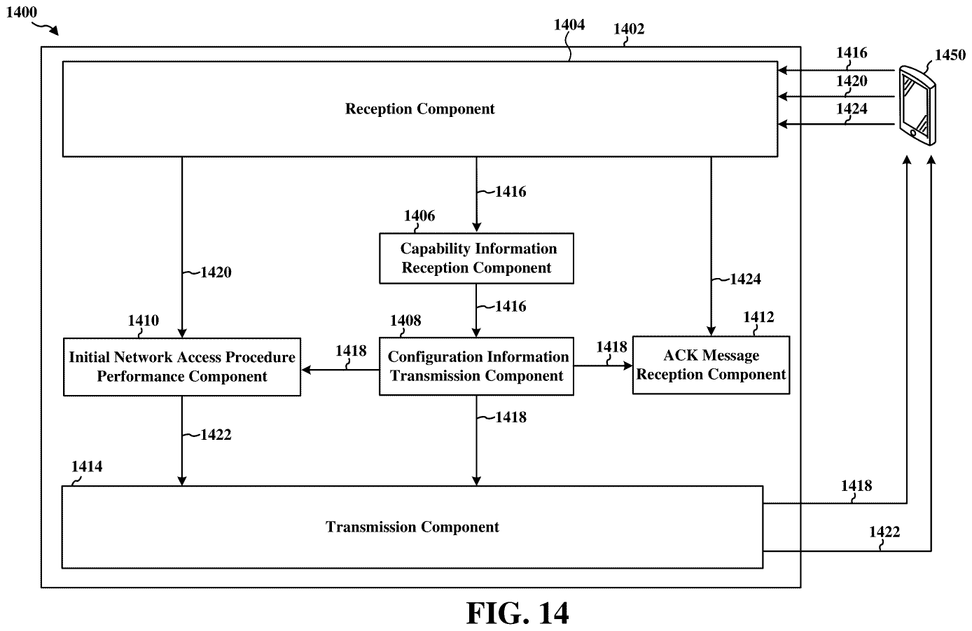

FIG. 14 is a conceptual data flow diagram 1400 illustrating the data flow between different means/components in an example apparatus 1402. The apparatus may be a network node. The apparatus includes a reception component 1404 that receives uplink signals from a UE 1450.

The apparatus further includes a capability information reception component 1406 that receives capability information 1416 (e.g., via the reception component 1404) indicating at least one of the energy harvesting class of the UE, the current charging rate of the UE, the current discharging rate of the UE, or the current energy state of the UE.

The apparatus further includes a configuration information transmission component 1408 that transmits configuration information 1418 associated with an initial network access procedure, wherein the configuration information 1418 is based on at least one of an energy harvesting class of the UE 1450, a current charging rate of the UE, the current discharging rate of the UE, or a current energy state of the UE. For example, configuration information transmission component 1408 receives the capability information 1416 from the capability information reception component 1406.

The apparatus further includes an initial network access procedure performance component 1410 that performs at least a portion of the initial network access procedure based on the configuration information 1418. For example, the initial network access procedure performance component 1410 may receive the configuration information 1418 from the configuration information transmission component 1408. For example, the initial network access procedure performance component 1410 may receive (e.g., via the reception component 1404) a message 1420 associated with an initial network access procedure and may transmit (e.g., via the transmission component 1414) a message 1422 associated with an initial network access procedure.

The apparatus further includes an acknowledgement message reception component 1412 that receives an acknowledgement message 1424 (e.g., via the reception component 1404) for a last message of the RACH procedure, wherein the acknowledgement message 1424 indicates an amount of time for a next communication at the UE. For example, the acknowledgement message reception component 1412 may receive the configuration information 1418 from the configuration information transmission component 1408.

The apparatus further includes a transmission component that transmits downlink signals to the UE 1450.

The apparatus may include additional components that perform each of the blocks of the algorithm in the aforementioned flowcharts of FIGS. 12 and 13. As such, each block in the aforementioned flowcharts of FIGS. 12 and 13 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

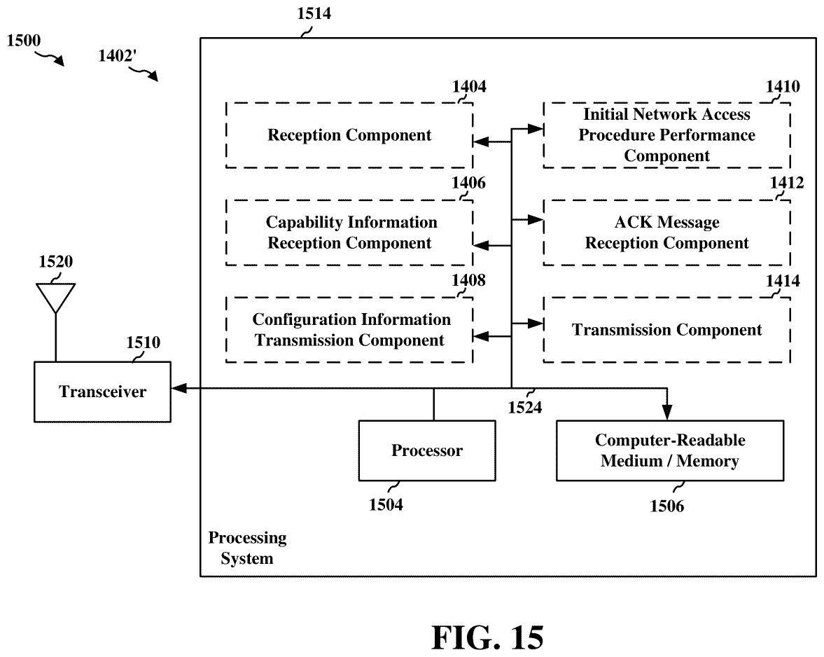

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410, 1412, 1414 and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1414, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system 1514 further includes at least one of the components 1404, 1406, 1408, 1410, 1412, 1414. The components may be software components running in the processor 1504, resident/stored in the computer readable medium/memory 1506, one or more hardware components coupled to the processor 1504, or some combination thereof. The processing system 1514 may be a component of the base station 310 and may include the memory 376 and/or at least one of the TX processor 316, the RX processor 370, and the controller/processor 375. Alternatively, the processing system 1514 may be the entire base station (e.g., see 310 of FIG. 3).

In one configuration, the apparatus 1402/1402′ for wireless communication includes means for transmitting configuration information associated with an initial network access procedure, wherein the configuration information is based on at least one of an energy harvesting class of a UE, a current charging rate of the UE, the current discharging rate of the UE, or a current energy state of the UE, means for performing at least a portion of the initial network access procedure based on the configuration information, receiving capability information indicating at least one of the energy harvesting class of the UE, the current charging rate of the UE, the current discharging rate of the UE, or the current energy state of the UE, means for receiving a first message of the four-step RACH procedure, wherein the first message indicates at least one of a first amount of time to transmit a second message of the four-step RACH procedure, a second amount of time to receive a third message of the four-step RACH procedure, or a third amount of time to transmit a fourth message of the four-step RACH procedure, means for receiving an acknowledgement message for a last message of the RACH procedure, wherein the acknowledgement message indicates an amount of time for a next communication at the UE.

The aforementioned means may be one or more of the aforementioned components of the apparatus 1402 and/or the processing system 1514 of the apparatus 1402′ configured to perform the functions recited by the aforementioned means. As described supra, the processing system 1514 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The following provides an overview of aspects of the present disclosure:
Aspect 1: An apparatus for wireless communication, comprising: a memory; and at least one processor coupled to the memory and configured to: receive configuration information associated with an initial network access procedure, wherein the configuration information is based on at least one of an energy harvesting class of the apparatus, a current charging rate of the apparatus, a current discharging rate of the apparatus, or a current energy state of the apparatus; and perform at least a portion of the initial network access procedure based on the configuration information.
Aspect 2: The apparatus of aspect 1, wherein the energy harvesting class of the apparatus is associated with at least one of a minimum charging rate of the apparatus, a default charging rate of the apparatus, a minimum discharging rate of the apparatus, a default discharging rate of the apparatus, a type of energy harvesting supported at the apparatus, a minimum time gap between two communications at the apparatus, or a capacity of an energy source of the apparatus.
Aspect 3: The apparatus of aspect 1 or 2, wherein the configuration information includes one or more parameter values for a signal transmission or a signal reception based on at least one of the energy harvesting class of the apparatus, the current charging rate of the apparatus, a current discharging rate of the apparatus, or the current energy state of the apparatus.
Aspect 4: The apparatus of any of aspects 1 through 3, wherein the configuration information includes one or more threshold values for one or more signal measurements associated with the initial network access procedure, wherein the at least one processor is further configured to: obtain the one or more signal measurements; and select a resource for a communication associated with the initial network access procedure based on the one or more threshold values in the configuration information and the one or more signal measurements.
Aspect 5: The apparatus of any of aspects 1 through 4, wherein the initial network access procedure includes at least one signal transmission from the apparatus, and wherein the configuration information includes at least one of power control information for the signal transmission, a maximum number of transmissions for the signal transmission, or one or more occasions to transmit the signal transmission.
Aspect 6: The apparatus of any of aspects 1 through 5, wherein the at least one processor is further configured to: transmit capability information indicating at least one of the energy harvesting class of the apparatus, the current charging rate of the apparatus, the current discharging rate of the apparatus, or the current energy state of the apparatus.
Aspect 7: The apparatus of any of aspects 1 through 6, wherein the configuration information is received before or during the initial network access procedure.
Aspect 8: The apparatus of any of aspects 1 through 7, wherein the configuration information is received in at least one of a synchronization signal block (SSB), a system information block (SIB), or a random access message.
Aspect 9: The apparatus of any of aspects 1 through 8, wherein the configuration information is received via a dedicated signaling in a connected mode.
Aspect 10: The apparatus of any of aspects 1 through 9, wherein the initial network access procedure includes a four-step random access channel (RACH) procedure, wherein the at least one processor configured to perform at least the portion of the initial network access procedure based on the configuration information is further configured to: transmit a first message of the four-step RACH procedure, wherein the first message indicates at least one of a first amount of time to receive a second message of the four-step RACH procedure, a second amount of time to transmit a third message of the four-step RACH procedure, or a third amount of time to receive a fourth message of the four-step RACH procedure.
Aspect 11: The apparatus of any of aspects 1 through 10, wherein the second amount of time is relative to a transmission time of the first message or a reception time of the second message, and wherein the third amount of time is relative to the transmission time of the first message, the reception time of the second message, or a transmission time of the third message.
Aspect 12: The apparatus of any of aspects 1 through 11, wherein the initial network access procedure includes a four-step random access channel (RACH) procedure, wherein the at least one processor configured to perform at least the portion of the initial network access procedure based on the configuration information is further configured to: transmit a message of the four-step RACH procedure, wherein the message indicates an amount of time to receive a last message of the four-step RACH procedure.
Aspect 13: The apparatus of any of aspects 1 through 12, wherein the initial network access procedure includes a two-step random access channel (RACH) procedure, wherein the at least one processor configured to perform at least the portion of the initial network access procedure based on the configuration information is further configured to: transmit a first message associated with a first step of the two-step RACH procedure, wherein the first message includes a preamble and indicates at least one of a first amount of time to transmit a second message associated with the first step, a second amount of time to receive a third message associated with a second step of the two-step RACH procedure, a third amount of time to receive a fourth message associated with the second step, or a fourth amount of time to transmit an acknowledgement for the fourth message.
Aspect 14: The apparatus of any of aspects 1 through 13, wherein at least one of the first amount of time, the second amount of time, the third amount of time, or the fourth amount of time is indicated as one of a duration relative to a reference time, an absolute time, or a codepoint from one or more preconfigured codepoints.
Aspect 15: The apparatus of any of aspects 1 through 14, wherein the first amount of time, the second amount of time, and the third amount of time are relative to a transmission time of the first message.
Aspect 16: The apparatus of any of aspects 1 through 15, wherein the third amount of time is relative to a reception time of the second message of the two-step RACH procedure.
Aspect 17: The apparatus of any of aspects 1 through 16, wherein the fourth amount of time is relative to a transmission time of the first message or a reception time of the second message.
Aspect 18: The apparatus of any of aspects 1 through 17, wherein the configuration information includes a maximum allowed time gap between two communications associated with the initial network access procedure, wherein the maximum allowed time gap is based on at least the energy harvesting class of the apparatus.
Aspect 19: The apparatus of any of aspects 1 through 18, wherein the initial network access procedure includes a random access channel (RACH) procedure, wherein the at least one processor is further configured to: transmit an acknowledgement message for a last message of the RACH procedure, wherein the acknowledgement message indicates an amount of time for a next communication at the apparatus.
Aspect 20: A method of wireless communication of a user equipment (UE), comprising: receiving configuration information associated with an initial network access procedure, wherein the configuration information is based on at least one of an energy harvesting class of the UE, a current charging rate of the UE, a current discharging rate of the UE, or a current energy state of the UE; and performing at least a portion of the initial network access procedure based on the configuration information.
Aspect 21: The method of aspect 20, wherein the configuration information includes one or more threshold values for one or more signal measurements associated with the initial network access procedure, further comprising: obtaining the one or more signal measurements; and selecting a resource for a communication associated with the initial network access procedure based on the one or more threshold values and the one or more signal measurements.
Aspect 22: The method of aspect 20 or 21, further comprising: transmitting capability information indicating at least one of the energy harvesting class of the UE, the current charging rate of the UE, the current discharging rate of the UE, or the current energy state of the UE.
Aspect 23: The method of any of aspects 20 through 22, wherein the initial network access procedure includes a random access channel (RACH) procedure, further comprising: transmitting an acknowledgement message for a last message of the RACH procedure, wherein the acknowledgement message indicates an amount of time for a next communication at the UE.
Aspect 24: An apparatus for wireless communication, comprising: a memory; and at least one processor coupled to the memory and configured to: transmit configuration information associated with an initial network access procedure, wherein the configuration information is based on at least one of an energy harvesting class of a user equipment (UE), a current charging rate of the UE, a current discharging rate of the UE, or a current energy state of the UE; and perform at least a portion of the initial network access procedure based on the configuration information.
Aspect 25: The apparatus of aspect 24, wherein the energy harvesting class of the UE is associated with at least one of a minimum charging rate of the UE, a default charging rate of the UE, a minimum discharging rate of the UE, a default discharging rate of the UE, a type of energy harvesting supported at the UE, a minimum time gap between two communications at the UE, or a capacity of an energy source of the UE.
Aspect 26: The apparatus of aspect 24 or 25, wherein the configuration information includes one or more parameter values for a signal transmission at the UE or a signal reception at the UE based on at least one of the energy harvesting class of the UE, the current charging rate of the UE, the current discharging rate of the UE, or the current energy state of the UE.
Aspect 27: The apparatus of any of aspects 24 through 26, wherein the at least one processor is further configured to: receive capability information indicating at least one of the energy harvesting class of the UE, the current charging rate of the UE, the current discharging rate of the UE, or the current energy state of the UE.
Aspect 28: The apparatus of any of aspects 24 through 27, wherein the initial network access procedure includes a four-step random access channel (RACH) procedure, wherein the at least one processor configured to perform at least the portion of the initial network access procedure based on the configuration information is further configured to: receive a first message of the four-step RACH procedure, wherein the first message indicates at least one of a first amount of time to transmit a second message of the four-step RACH procedure, a second amount of time to receive a third message of the four-step RACH procedure, or a third amount of time to transmit a fourth message of the four-step RACH procedure.
Aspect 29: The apparatus of any of aspects 24 through 28, wherein the configuration information includes a maximum allowed time gap between two communications associated with the initial network access procedure, wherein the maximum allowed time gap is based on at least the energy harvesting class of the UE.
Aspect 30: The apparatus of any of aspects 24 through 29, wherein the initial network access procedure includes a random access channel (RACH) procedure, wherein the at least one processor is further configured to: receive an acknowledgement message for a last message of the RACH procedure, wherein the acknowledgement message indicates an amount of time for a next communication at the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. An apparatus for wireless communication, comprising:
a memory; and
at least one processor coupled to the memory and configured to:
receive configuration information associated with an initial network access procedure, wherein the configuration information is based on at least one of an energy harvesting class of the apparatus, a current charging rate of the apparatus, a current discharging rate of the apparatus, or a current energy state of the apparatus; and
perform at least a portion of the initial network access procedure based on the configuration information.

2. The apparatus of claim 1, wherein the energy harvesting class of the apparatus is associated with at least one of a minimum charging rate of the apparatus, a default charging rate of the apparatus, a minimum discharging rate of the apparatus, a default discharging rate of the apparatus, a type of energy harvesting supported at the apparatus, a minimum time gap between two communications at the apparatus, or a capacity of an energy source of the apparatus.

3. The apparatus of claim 1, wherein the configuration information includes one or more parameter values for a signal transmission or a signal reception based on at least one of the energy harvesting class of the apparatus, the current charging rate of the apparatus, the current discharging rate of the apparatus, or the current energy state of the apparatus.

4. The apparatus of claim 1, wherein the configuration information includes one or more threshold values for one or more signal measurements associated with the initial network access procedure, wherein the at least one processor is further configured to:
obtain the one or more signal measurements; and
select a resource for a communication associated with the initial network access procedure based on the one or more threshold values in the configuration information and the one or more signal measurements.

5. The apparatus of claim 1, wherein the initial network access procedure includes at least one signal transmission from the apparatus, and wherein the configuration information includes at least one of power control information for the signal transmission, a maximum number of transmissions for the signal transmission, or one or more occasions to transmit the signal transmission.

6. The apparatus of claim 1, wherein the at least one processor is further configured to:
transmit capability information indicating at least one of the energy harvesting class of the apparatus, the current charging rate of the apparatus, the current discharging rate of the apparatus, or the current energy state of the apparatus.

7. The apparatus of claim 1, wherein the configuration information is received before or during the initial network access procedure.

8. The apparatus of claim 7, wherein the configuration information is received in at least one of a synchronization signal block (SSB), a system information block (SIB), or a random access message.

9. The apparatus of claim 1, wherein the configuration information is received via a dedicated signaling in a connected mode.

10. The apparatus of claim 1, wherein the initial network access procedure includes a four-step random access channel (RACH) procedure, wherein the at least one processor configured to perform at least the portion of the initial network access procedure based on the configuration information is further configured to:
transmit a first message of the four-step RACH procedure, wherein the first message indicates at least one of a first amount of time to receive a second message of the four-step RACH procedure, a second amount of time to transmit a third message of the four-step RACH procedure, or a third amount of time to receive a fourth message of the four-step RACH procedure.

11. The apparatus of claim 10, wherein the second amount of time is relative to a transmission time of the first message or a reception time of the second message, and wherein the third amount of time is relative to the transmission time of the first message, the reception time of the second message, or a transmission time of the third message.

12. The apparatus of claim 1, wherein the initial network access procedure includes a four-step random access channel (RACH) procedure, wherein the at least one processor configured to perform at least the portion of the initial network access procedure based on the configuration information is further configured to:
transmit a message of the four-step RACH procedure, wherein the message indicates an amount of time to receive a last message of the four-step RACH procedure.

13. The apparatus of claim 1, wherein the initial network access procedure includes a two-step random access channel (RACH) procedure, wherein the at least one processor configured to perform at least the portion of the initial network access procedure based on the configuration information is further configured to:
transmit a first message associated with a first step of the two-step RACH procedure, wherein the first message includes a preamble and indicates at least one of a first amount of time to transmit a second message associated with the first step, a second amount of time to receive a third message associated with a second step of the two-step RACH procedure, a third amount of time to receive a fourth message associated with the second step, or a fourth amount of time to transmit an acknowledgement for the fourth message.

14. The apparatus of claim 13, wherein at least one of the first amount of time, the second amount of time, the third amount of time, or the fourth amount of time is indicated as one of a duration relative to a reference time, an absolute time, or a codepoint from one or more preconfigured codepoints.

15. The apparatus of claim 13, wherein the first amount of time, the second amount of time, and the third amount of time are relative to a transmission time of the first message.

16. The apparatus of claim 13, wherein the third amount of time is relative to a reception time of the second message of the two-step RACH procedure.

17. The apparatus of claim 13, wherein the fourth amount of time is relative to a transmission time of the first message or a reception time of the second message.

18. The apparatus of claim 1, wherein the configuration information includes a maximum allowed time gap between two communications associated with the initial network access procedure, wherein the maximum allowed time gap is based on at least the energy harvesting class of the apparatus.

19. The apparatus of claim 1, wherein the initial network access procedure includes a random access channel (RACH) procedure, wherein the at least one processor is further configured to:
transmit an acknowledgement message for a last message of the RACH procedure, wherein the acknowledgement message indicates an amount of time for a next communication at the apparatus.

20. A method of wireless communication of a user equipment (UE), comprising:
receiving configuration information associated with an initial network access procedure, wherein the configuration information is based on at least one of an energy harvesting class of the UE, a current charging rate of the UE, a current discharging rate of the UE, or a current energy state of the UE; and
performing at least a portion of the initial network access procedure based on the configuration information.

21. The method of claim 20, wherein the configuration information includes one or more threshold values for one or more signal measurements associated with the initial network access procedure, further comprising:
obtaining the one or more signal measurements; and
selecting a resource for a communication associated with the initial network access procedure based on the one or more threshold values and the one or more signal measurements.

22. The method of claim 20, further comprising:
transmitting capability information indicating at least one of the energy harvesting class of the UE, the current charging rate of the UE, the current discharging rate of the UE, or the current energy state of the UE.

23. The method of claim 20, wherein the initial network access procedure includes a random access channel (RACH) procedure, further comprising:
transmitting an acknowledgement message for a last message of the RACH procedure, wherein the acknowledgement message indicates an amount of time for a next communication at the UE.

24. An apparatus for wireless communication, comprising:
a memory; and
at least one processor coupled to the memory and configured to:
transmit configuration information associated with an initial network access procedure, wherein the configuration information is based on at least one of an energy harvesting class of a user equipment (UE), a current charging rate of the UE, a current discharging rate of the UE, or a current energy state of the UE; and
perform at least a portion of the initial network access procedure based on the configuration information.

25. The apparatus of claim 24, wherein the energy harvesting class of the UE is associated with at least one of a minimum charging rate of the UE, a default charging rate of the UE, a minimum discharging rate of the UE, a default discharging rate of the UE, a type of energy harvesting supported at the UE, a minimum time gap between two communications at the UE, or a capacity of an energy source of the UE.

26. The apparatus of claim 24, wherein the configuration information includes one or more parameter values for a signal transmission at the UE or a signal reception at the UE based on at least one of the energy harvesting class of the UE, the current charging rate of the UE, the current discharging rate of the UE, or the current energy state of the UE.

27. The apparatus of claim 24, wherein the at least one processor is further configured to:
receive capability information indicating at least one of the energy harvesting class of the UE, the current charging rate of the UE, the current discharging rate of the UE, or the current energy state of the UE.

28. The apparatus of claim 24, wherein the initial network access procedure includes a four-step random access channel (RACH) procedure, wherein the at least one processor configured to perform at least the portion of the initial network access procedure based on the configuration information is further configured to:
receive a first message of the four-step RACH procedure, wherein the first message indicates at least one of a first amount of time to transmit a second message of the four-step RACH procedure, a second amount of time to receive a third message of the four-step RACH procedure, or a third amount of time to transmit a fourth message of the four-step RACH procedure.

29. The apparatus of claim 24, wherein the configuration information includes a maximum allowed time gap between two communications associated with the initial network access procedure, wherein the maximum allowed time gap is based on at least the energy harvesting class of the UE.

30. The apparatus of claim 24, wherein the initial network access procedure includes a random access channel (RACH) procedure, wherein the at least one processor is further configured to:
receive an acknowledgement message for a last message of the RACH procedure, wherein the acknowledgement message indicates an amount of time for a next communication at the UE.
